(19) United States
(12) Patent Application Publication
(10) Pub. No.: US 2022/0224624 A1
(43) Pub. Date: Jul. 14, 2022

(54) METHODS, APPARATUS, AND ARTICLES OF MANUFACTURE TO IMPROVE BANDWIDTH FOR PACKET TIMESTAMPING

(71) Applicant: Intel Corporation, Santa Clara, CA (US)

(72) Inventor: Kishore Kasichainula, Phoenix, AZ (US)

(21) Appl. No.: 17/709,639

(22) Filed: Mar. 31, 2022

(51) Int. Cl. H04L 43/106; H04L 43/0894; H04L 41/0896

(52) U.S. Cl. CPC H04L 43/106; H04L 41/0896; H04L 43/0894

(57) ABSTRACT

Methods, apparatus, systems, and articles of manufacture are disclosed to improve bandwidth for packet timestamping. An example apparatus includes cache to store a pointer, the pointer indicative of an address in shared memory where a timestamp is to be stored, the pointer corresponding to a descriptor of data to be transmitted to a second device. The example apparatus also includes memory access control circuitry to parse the descriptor to determine the pointer and cause storage of the pointer in the cache. Additionally, the memory access control circuitry of the example apparatus is to set a control bit of the descriptor to indicate that the descriptor may be overwritten.

### FIELD OF THE DISCLOSURE

This disclosure relates generally to networking and, more particularly, to methods, apparatus, and articles of manufacture to improve bandwidth for packet timestamping.

### BACKGROUND

Multi-access edge computing (MEC) is a network architecture concept that enables cloud compute capabilities and an infrastructure technology service environment at the edge of a network, such as a cellular network. Using MEC, data center cloud services and applications can be processed closer to an end user or compute device to improve network operation.

### BRIEF DESCRIPTION OF THE DRAWINGS

FIG. 1 illustrates an overview of an Edge cloud configuration for Edge computing.

FIG. 2 illustrates operational layers among endpoints, an Edge cloud, and cloud compute environments.

FIG. 3 illustrates an example approach for networking and services in an Edge compute system.

FIG. 4 illustrates example levels of an example information technology (IT)/operational technology (OT) environment.

FIG. 5 illustrates an example block diagram of an example shared memory of a compute platform including network interface circuitry (NIC) and main processor circuitry.

FIG. 6 is a block diagram of an example compute platform including an example shared memory, example network interface circuitry (NIC), and example main processor circuitry.

FIG. 7 illustrates an example block diagram of the example shared memory of the compute platform of FIG. 6.

FIG. 8 is a flowchart representative of example machine-readable instructions and/or example operations that may be executed and/or instantiated by example processor circuitry to implement the example NIC of FIG. 6.

FIG. 9 is a block diagram of an example processing platform including processor circuitry structured to execute the example machine readable instructions and/or the example operations of FIG. 8 to implement the NIC of FIG. 6.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIG. 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “about” refer to measurements that may not be exact due to measurement device tolerances and/or other real world imperfections. As used herein “substantially real time” refers to occurrence in a near instantaneous manner recognizing there may be real world delays for compute time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous compute system including multiple types of processor circuitry (e.g., one or more FPGAs, one or more CPUs, one or more GPUs, one or more DSPs, etc., and/or a combination thereof) and application programming interface(s) (API(s)) that may assign compute task(s) to whichever one(s) of the multiple types of the processing circuitry is/are best suited to execute the compute task(s).

### DETAILED DESCRIPTION

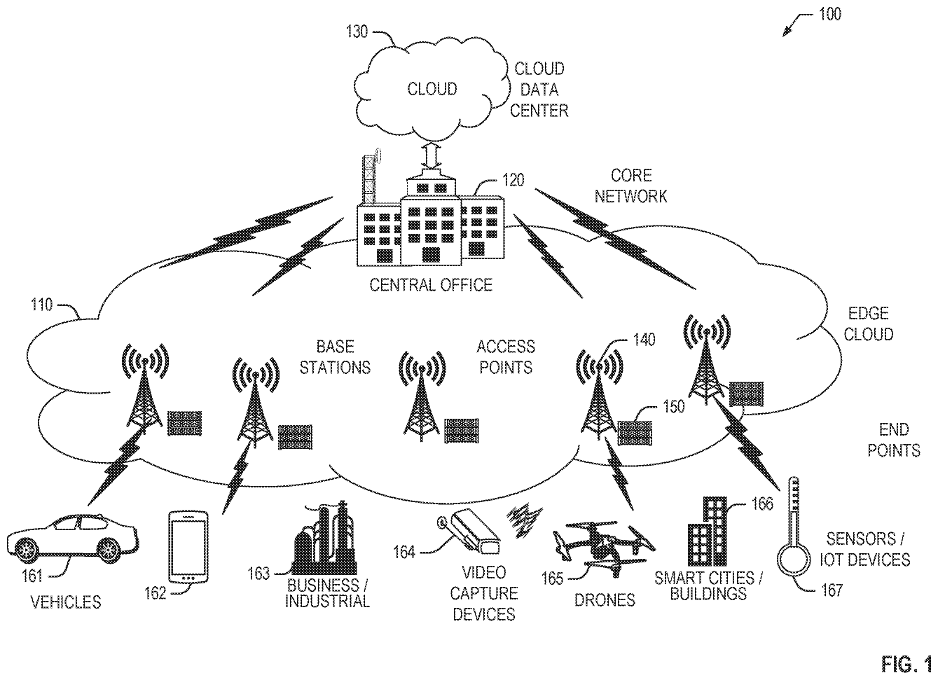

FIG. 1 is a block diagram 100 showing an overview of a configuration for edge computing, which includes a layer of processing referred to in many of the following examples as an “edge cloud.” As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and Internet-of-Things (IoT) devices 167, etc.) than the cloud data center 130. Compute, memory, and storage resources that are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. For example, such processing can consume a disproportionate amount of bandwidth of processing resources closer to the end user or compute device thereby increasing latency, congestion, and power consumption of the network. Thus, edge computing attempts to reduce the amount of resources needed for network services, through the distribution of more resources which are located closer both geographically and in network access time. In this manner, edge computing attempts to bring the compute resources to the workload data where appropriate or bring the workload data to the compute resources. As used herein, data is information in any form that may be ingested, processed, interpreted and/or otherwise manipulated by processor circuitry to produce a result. The produced result may itself be data.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computation is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge compute networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 1, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, industrial applications, automotive applications, etc. and may fail in attempting to meet latency challenges.

Depending on the real-time requirements in a communications context, a hierarchical structure of data processing and storage nodes may be defined in an edge compute deployment. For example, such a deployment may include local ultra-low-latency processing, regional storage, and processing as well as remote cloud datacenter-based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud datacenter. At a more generic level, an edge compute system may be described to encompass any number of deployments operating in the edge cloud 110, which provide coordination from client and distributed compute devices.

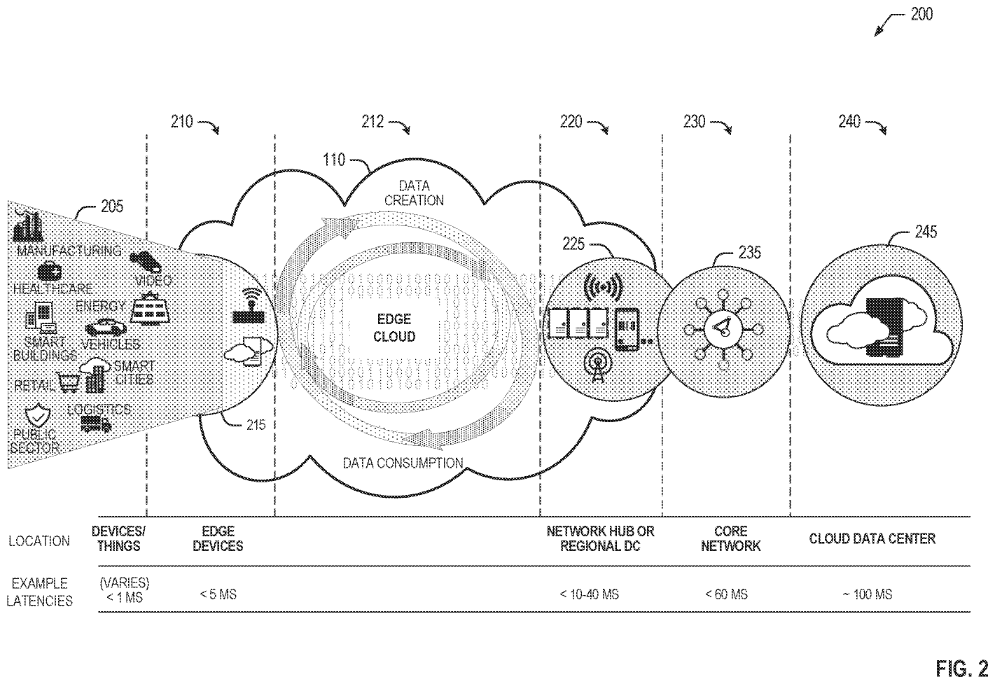

FIG. 2 illustrates operational layers among endpoints, an edge cloud, and cloud compute environments. Specifically, FIG. 2 depicts examples of computational use cases 205, utilizing the edge cloud 110 of FIG. 1 among multiple illustrative layers of network compute. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer 240). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge,” “local edge,” “near edge,” “middle edge,” or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close,” “local,” “near,” “middle,” or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure substantially real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., virtual network functions (VNFs), FaaS, Edge as a Service (EaaS), standard processes, etc.), which cannot leverage conventional cloud compute due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 110 in a multi-tenant, multi-owner, or multi-access setting, where many users request services and applications, especially as network usage dynamically fluctuates and the composition of the multiple stakeholders, use cases, and services changes.

At a more generic level, an edge compute system may be described to encompass any number of deployments at the previously discussed layers operating in the edge cloud 110 (network layers 210-230), which provide coordination from client and distributed compute devices. One or more edge gateway nodes, one or more edge aggregation nodes, and one or more core data centers may be distributed across layers of the network to provide an implementation of the edge compute system by or on behalf of a telecommunication service provider (“telco”, or “TSP”), internet-of-things service provider, cloud service provider (CSP), enterprise entity, or any other number of entities. Various implementations and configurations of the edge compute system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge compute system does not necessarily mean that such node or device operates in a client or agent/minion/follower role; rather, any of the nodes or devices in the edge compute system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge compute and/or storage resources which are proximately located to RAN capable endpoint devices (e.g., mobile compute devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 110 may be servers, multi-tenant servers, appliance compute devices, and/or any other type of compute devices. For example, the edge cloud 110 may include an appliance compute device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, light emitting diodes (LEDs), speakers, I/O ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include IoT devices. The appliance compute device may include hardware and software components to manage local issues such as device temperature, vibration, resource utilization, updates, power issues, physical and network security, etc. The edge cloud 110 may also include one or more servers and/or one or more multi-tenant servers. Such a server may include an operating system and a virtual compute environment. A virtual compute environment may include a hypervisor managing (spawning, deploying, destroying, etc.) one or more virtual machines, one or more containers, etc. Such virtual compute environments provide an execution environment in which one or more applications and/or other software, code or scripts may execute while being isolated from one or more other applications, software, code, or scripts.

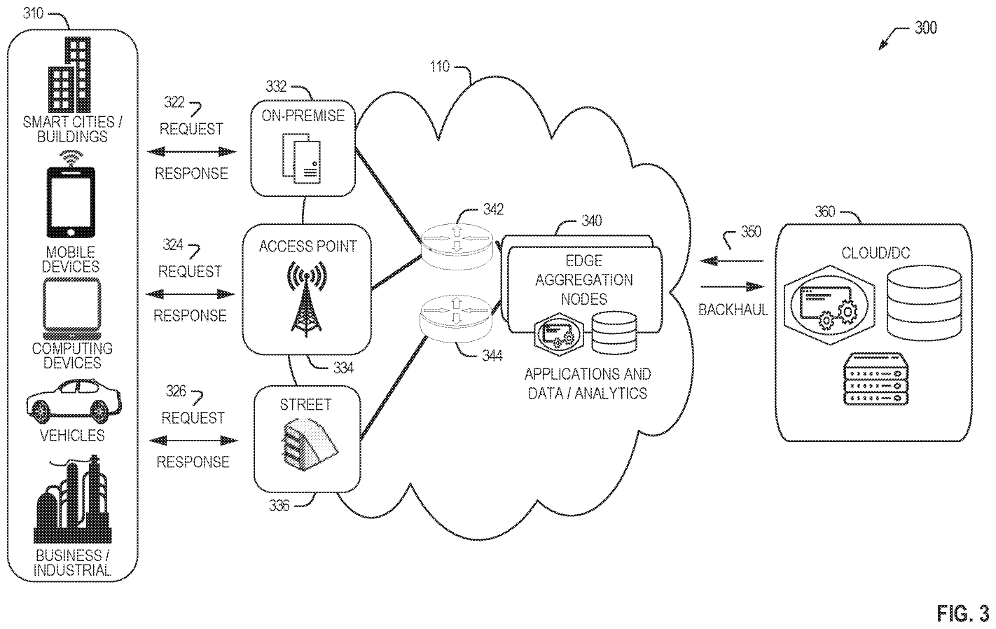

In FIG. 3, various client endpoints 310 (in the form of mobile devices, computers, autonomous vehicles, business compute equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile compute devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 of FIG. 1 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center (DC) 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

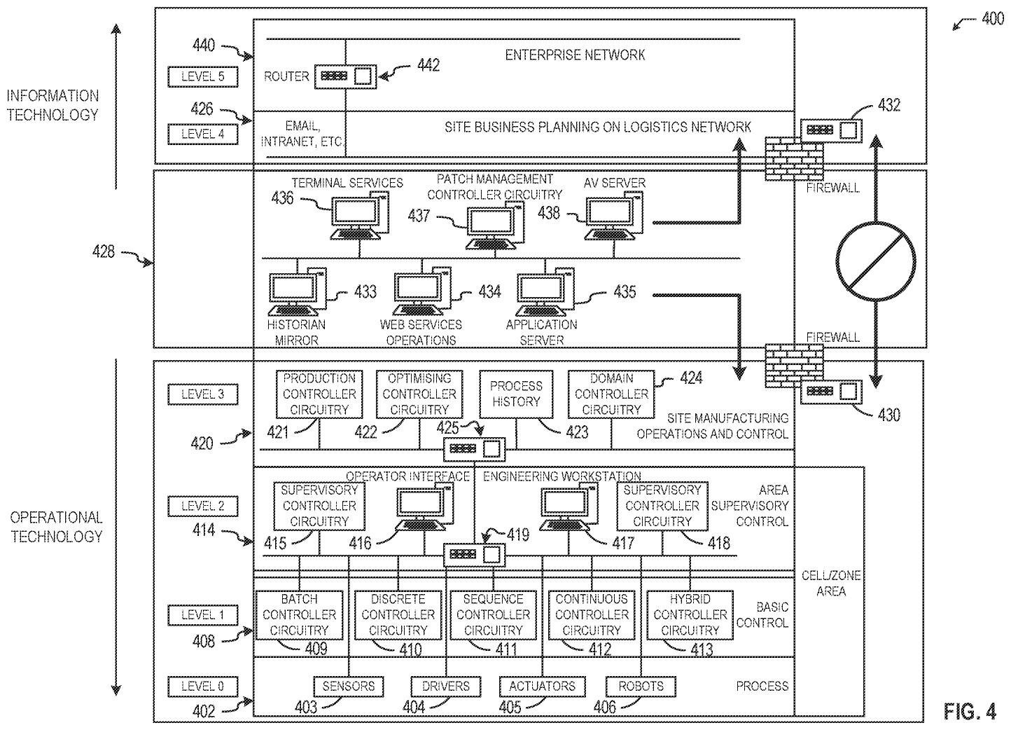

FIG. 4 illustrates example levels of an example IT/OT environment 400. In the example of FIG. 4, the IT/OT environment 400 implements an industrial control system (ICS) that controls a manufacturing and/or other production process. In the example of FIG. 4, the IT/OT environment 400 includes six functional levels representative of hierarchical functions of devices and/or equipment and the interconnections and interdependencies of an example IT/OT environment such as an ICS. The IT/OT environment 400 includes an example level zero 402 corresponding to physical processes. In the example of FIG. 4, physical equipment that performs the actual physical processes reside in the level zero 402. For example, the level zero 402 includes one or more example sensors 403, one or more example drives 404 (e.g., one or more motors), one or more example actuators 405, and one or more example robots 406. In some examples, the level zero 402 includes one or more additional or alternative devices.

In the illustrated example of FIG. 4, the IT/OT environment 400 includes an example level one 408 corresponding to individual control of the respective one or more physical processes of the level zero 402. In the example of FIG. 4, the level one 408 includes example batch controller circuitry 409, example discrete controller circuitry 410 (e.g., one or more proportional-integral-derivative (PID) controllers, one or more open loop controllers, etc.), example sequence controller circuitry 411 (e.g., one or more sequential controllers with interlock logic), example continuous controller circuitry 412 (e.g., performing continuous process control), and example hybrid controller circuitry 413 (e.g., one or more specialized controllers providing capabilities not found in standard controllers such as adaptive control, artificial intelligence, and fuzzy logic). In some examples, the level one 408 includes one or more additional or alternative controllers such as those performing ratio control, feed-forward control, cascade control, and multivariable process control. In the example of FIG. 4, any of the batch controller circuitry 409, the discrete controller circuitry 410, the sequence controller circuitry 411, the continuous controller circuitry 412, and the hybrid controller circuitry 413 may be implemented by one or more programmable logic controllers (PLC(s)). As used herein, the terms controller and/or controller circuitry is a type of processor circuitry and may include one or more of analog circuit(s), digital circuit(s), logic circuit(s), programmable microprocessor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Array (FPGAs).

In the illustrated example of FIG. 4, the IT/OT environment 400 includes an example level two 414 corresponding to control of the one or more controllers of the level one 408. In the example of FIG. 4, the level two 414 includes an ICS such a human machine interface (HMI) system and/or a supervisory control and data acquisition (SCADA) system to supervise, monitor, and/or control the one or more controllers of the level one 408. In the example of FIG. 4, the level two 414 includes example first supervisory controller circuitry 415 (e.g., an HMI system, a SCADA system, etc.), an example operator interface 416, an example engineering workstation 417, and example second supervisory controller circuitry 418 (e.g., an HMI system, a SCADA system, etc.). In the example of FIG. 4, the operator interface 416 and the engineering workstation 417 are implemented by one or more computers (e.g., laptops, desktop computers, etc.).

In the illustrated example of FIG. 4, the first supervisory controller circuitry 415, the operator interface 416, the engineering workstation 417, and the second supervisory controller circuitry 418 communicate with the one or more controllers and/or devices of the level one 408 and the level zero 402 via an example first aggregation point 419. In the example of FIG. 4, the first aggregation point 419 is implemented by a router. In some examples, the first aggregation point 419 is implemented by a gateway, a router and a modem, a network switch, a network hub, among others.

In the illustrated example of FIG. 4, the IT/OT environment 400 includes an example level three 420 corresponding to manufacturing execution systems that manage production workflow on the manufacturing floor (e.g., the level zero 402). In some examples, the level three 420 includes customized systems for certain functions such as batch management, record data, management operations, and overall manufacturing plant performance. In the example of FIG. 4, the level three 420 includes example production controller circuitry 421, example optimizing controller circuitry 422 (e.g., performing optimal control), an example process history database 423 (e.g., to record data associated with one or more physical processes), and example domain controller circuitry 424 (e.g., one or more servers that control the security of network domain of the level zero 402, the level one 408, the level two 414, and the level three 420).

In some examples, the production controller circuitry 421, the optimizing controller circuitry 422 (e.g., performing optimal control), the process history database 423, and/or the domain controller circuitry 424 aggregate and/or process lower level data (e.g., from the level zero 402, the level one 408, and/or the level two 414) and forward the aggregated and/or processed data to upper levels of the IT/OT environment 400. In the example of FIG. 4, the production controller circuitry 421, the optimizing controller circuitry 422 (e.g., performing optimal control), the process history database 423, and the domain controller circuitry 424 communicate with the one or more controllers, one or more interfaces, one or more workstations, and/or one or more devices of the level two 414, the level one 408, and the level zero 402, via an example second aggregation point 425. In the example of FIG. 4, the second aggregation point 425 is implemented similarly to the first aggregation point 419.

In the illustrated example of FIG. 4, the IT/OT environment 400 includes an example level four 426 that is separated from the level three 420, the level two 414, the level one 408, and the level zero 402 by an example demilitarized zone (DMZ) 428. In the example of FIG. 4, the DMZ 428 corresponds to one or more security systems such as one or more firewalls, and/or one or more proxies that regulate (e.g., moderate, police, etc.) bidirectional data flow between the level three 420, the level two 414, the level one 408, the level zero 402 and upper levels (e.g., the level four 426) of the IT/OT environment 400. The example DMZ 428 permits the exchange of data between the highly secure, highly connected upper level networks (e.g., business networks) of the IT/OT environment 400 and the less secure, less connected lower level networks (e.g., ICS networks) of the IT/OT environment 400.

In the illustrated example of FIG. 4, the lower levels (e.g., the level three 420, the level two 414, the level one 408, and the level zero 402) of the IT/OT environment 400 communicate with the DMZ 428 via an example third aggregation point 430. Additionally, the DMZ 428 communicates with the upper levels (e.g., the level four 426) of the IT/OT environment 400 via an example fourth aggregation point 432. In the example of FIG. 4, each of the third aggregation point 430 and the fourth aggregation point 432 is implemented similarly to the first aggregation point 419 and the second aggregation point 425 except that each of the third aggregation point 430 and the fourth aggregation point 432 implements a firewall.

In the illustrated example of FIG. 4, the DMZ 428 includes an example historian mirror server 433 (e.g., implemented by one or more computers and/or one or more memories), example web service operations controller circuitry 434 (e.g., implemented by one or more computers and/or one or more memories), an example application server 435 (e.g., implemented by one or more computers and/or one or more memories), an example terminal server 436 (e.g., implemented by one or more computers and/or one or more memories), example patch management controller circuitry 437 (e.g., implemented by one or more computers and/or one or more memories), and an example antivirus server 438 (e.g., implemented by one or more computers and/or one or more memories). In the example of FIG. 4, the historian mirror server 433 manages incoming and/or outgoing data, storage of the data, compression of the data, and/or retrieval of the data. In the example of FIG. 4, the web service operations controller circuitry 434 controls Internet-based direct application-to-application interaction via an extensible markup language (XML) based information exchange system.

In the illustrated the example of FIG. 4, the application server 435 hosts applications. In the example of FIG. 4, the terminal server 436 provides terminals (e.g., computers, printers, etc.) with a common connection point to a local area network (LAN) or wide area network (WAN). In the example of FIG. 4, the patch management controller circuitry 437 manages the retrieval, testing, and installation of one or more patches (e.g., code changes, updates, etc.) on existing applications and software (e.g., the applications hosted by the application server 435). In the example of FIG. 4, the antivirus server 438 manages antivirus software.

In the illustrated example of FIG. 4, the IT/OT environment 400 includes the level four 426 corresponding to IT systems such as email and intranet, among others. In the example of FIG. 4, the level four 426 includes one or more IT networks including enterprise resource planning (ERP) systems, databases servers, application servers, and file servers that facilitate business logistics systems such as site business planning and logistics networking.

In the illustrated example of FIG. 4, the IT/OT environment 400 includes an example level five 440 corresponding to one or more enterprise (e.g., corporate) networks. In the example of FIG. 4, the level five 440 includes one or more enterprise IT systems that cover communications with the Internet. In the example of FIG. 4, one or more devices in the level five 440 communicate with one or more devices in the level four 426 via an example fifth aggregation point 442. In the example of FIG. 4, the fifth aggregation point 442 is implemented similarly to the first aggregation point 419 and the second aggregation point 425.

In the illustrated example of FIG. 4, the level zero 402, the level one 408, the level two 414, and the level three 420 correspond to the OT portion of the IT/OT environment 400. Within the OT portion, the level zero 402, the level one 408, and the level two 414 form an example cell/zone area. In the example of FIG. 4, the level four 426 and the level five 440 form the IT portion of the IT/OT environment 400.

In the illustrated example of FIG. 4, one or more of the first aggregation point 419, the second aggregation point 425, the third aggregation point 430, the fourth aggregation point 432, the fifth aggregation point 442, the batch controller circuitry 409, the discrete controller circuitry 410, the sequence controller circuitry 411, the continuous controller circuitry 412, the hybrid controller circuitry 413, the first supervisory controller circuitry 415, the operator interface 416, the engineering workstation 417, and the second supervisory controller circuitry 418, the production controller circuitry 421, the optimizing controller circuitry 422, the process history database 423, the domain controller circuitry 424, the historian mirror server 433, the web service operations controller circuitry 434, the application server 435, the terminal server 436, the patch management controller circuitry 437, and/or the antivirus server 438 integrate edge compute, devices, IT-enabled software, and/or one or more applications directed to productivity, reliability, and/or safety.

As the IT/OT environment 400 implements an ICS that controls a manufacturing and/or other production process, some of the processes may be time sensitive. Accordingly, the Institute of Electrical and Electronics Engineers (IEEE) has developed standards to handle such time sensitive processes. For example, the emerging IEEE standards for deterministic networking, referred to collectively as time sensitive networking (TSN) standards, provide extremely precise data transfer across a network. As a result, embedded designs (e.g., any of the devices of the IT/OT environment 400) in industrial and/or automotive environments (e.g., the IT/OT environment 400) are increasingly integrating TSN controllers. Other time sensitive uses cases are possible including aerospace, audio video bridging (e.g., audio and/or video studio, infotainment systems, etc.), automotive (e.g., self-driving vehicles, communication of sensor data in automotive networks, etc.), cellular network (e.g., fronthaul networks, 5G mobile networks generally, etc.) and/or utility (e.g., power automation) applications, among others.

TSN controllers may be implemented by network interface circuitry (NIC) based on the capabilities of the NIC. As used herein, NIC refers to Network Interface Circuitry. Although the term NIC does not require the use of an indefinite article (e.g., “a” or “an”) and may operate as both a singular and plural noun, in some examples indefinite articles are used with the term NIC and/or an “s” is added to the term NIC to improve readability. In some examples, a NIC may or may not be implemented on a card. In some examples, a NIC may be implemented as part of a system on a chip (SoC) and configured to operate in conjunction with main processor circuitry (e.g., a CPU) of the SoC. A NIC may include memory access control circuitry (e.g., direct memory access (DMA) control circuitry), media access control (MAC) circuitry (e.g., media access control circuitry), and one or more caches.

With the increasing convergence of IT and OT environments, workload consolidation and demand for seamless communication across many connected devices are imposing increased requirements for embedded designs. For example, such requirements include that TSN controllers be compatible with various types of data traffic, have precise scheduling of the data, and do not sacrifice latency for hard real-time applications.

To support the various types of data traffic, the “IEEE Standard for Local and Metropolitan Area Network—Bridges and Bridged Networks,” in IEEE Std 802.1Q-2018 (Revision of IEEE Std 802.1Q-2014), vol., no., pp. 1-1993, 6 Jul. 2018 (referred to hereinafter as “the IEEE 802.1Q standard”) defines eight traffic classes (e.g., TC0-TC7) for all data streams. Each traffic class is subject to different parameters (e.g., quality of service (QoS)). In industrial applications, high priority, hard real-time, traffic is classified as TC7-TC5. Similarly, non-real-time, best effort traffic (e.g., best effort data stream(s)) is classified as TC4-TC0. As used herein, real-time traffic and/or real-time data stream(s) refers to network traffic associated with a compute application in which success of the compute application is dependent on the logical correctness of the outcome of the compute application as well as whether the outcome of the compute application was provided with a specified time constraint known as a deadline. As used herein, hard real-time traffic and/or hard real-time data stream(s) refers to real-time traffic associated with a compute application where failure to meet a deadline constitutes failure of the compute application. As used herein, best effort traffic and/or best effort data stream(s) refers to network traffic associated with a compute application that does not require an outcome with a specified time constraint.

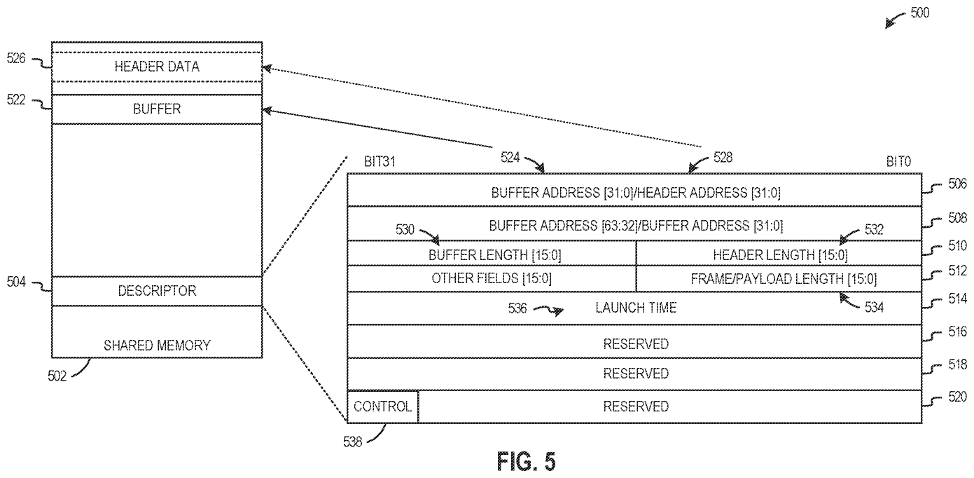

In example TSN applications, TSN capable NICs (e.g., a TSN NIC) include 8 transmit queues and 8 receive queues to accommodate the different traffic classes specified by the IEEE 802.1Q standard, where each transmit and receive queue pair is dedicated to one of the traffic classes. Payload data transmitted by a TSN NIC is associated with a descriptor. For example, to cause transmission of payload data, main processor circuitry stores payload data in a shared memory with the descriptor and the TSN NIC may access the descriptor to process the payload data for transmission. FIG. 5 illustrates an example block diagram 500 of an example shared memory 502 of a compute platform including a NIC and main processor circuitry. In the example of FIG. 5, the shared memory 502 is referred to as “shared” because the shared memory 502 may be accessed by both the NIC and the main processor circuitry.

In the illustrated example of FIG. 5, the shared memory 502 is implemented by one or more double data rate (DDR) memories, such as DDR, DDR2, DDR3, DDR4, DDR5, mobile DDR (mDDR), DDR Synchronous Dynamic Random Access Memory (SDRAM), etc. Additionally, in the example of FIG. 5, the shared memory 502 is implemented in the same package as a NIC and main processor circuitry that operate on the shared memory 502, but on a different die than the NIC and/or main processor circuitry (e.g., separate chiplets). For example, the shared memory 502 is implemented on a first die and the NIC and the main processor circuitry are implemented on a second die different from the first die. In some examples, the shared memory 502 is implemented on a first die, the NIC is implemented on a second die different from the first die, and the main processor circuitry is implemented on a third die different from the first die and the second die.

The example shared memory 502 may be implemented by a volatile memory (e.g., Static Random Access Memory (SRAM), SDRAM, Dynamic Random Access Memory (DRAM), RAMBUS Dynamic Random Access Memory (RDRAM), etc.) and/or a non-volatile memory (e.g., flash memory). For example, if the shared memory 502 is implemented as SRAM, the shared memory 502 may be implemented on the same die as the main processor circuitry and/or the same die as the NIC. In some examples, the shared memory 502 may be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the shared memory 502 is illustrated as a single memory, the shared memory 502 may be implemented by any number and/or type(s) of memories. Furthermore, the data stored in the shared memory 502 may be in any data format such as, for example, binary data, comma delimited data, tab delimited data, structured query language (SQL) structures, etc.

In the illustrated example of FIG. 5, the shared memory 502 includes an example descriptor 504. The example descriptor 504 is a data structure including eight rows (an example first row 506, an example second row 508, an example third row 510, an example fourth row 512, an example fifth row 514, an example sixth row 516, an example seventh row 518, and an example eighth row 520) where each row is 32 bits wide.

In the illustrated example of FIG. 5, the descriptor 504 may be formatted according to at least two configurations. The configuration of the descriptor 504 may be specified in a reserved field of the descriptor 504. In an example first configuration, the first row 506 and the second row 508 are to store a 64-bit address (e.g., 32 bits are to be stored in the first row 506 and 32 bits are to be stored in the second row 508) that points to a location in the shared memory 502 where an example payload buffer 522 of payload data is stored. In this manner, the 64-bit address operates as a buffer pointer 524. In the first configuration, the payload buffer 522 to which the buffer pointer 524 points is to store (1) payload data to be sent to a receiving device and (2) a header address indicative of a header of the receiving device. An example header includes an L2 MAC address, an L3 MAC address, an L4 MAC address, an L2 Internet Protocol (IP) address, an L3 IP address, an L4 IP address, an L2 port address, an L3 port address, or an L4 port address.

In the illustrated example of FIG. 5, in an example second configuration, the first row 506 is to store a 32-bit address that points to a location in the shared memory 502 where example header data 526 indicative of a header of a receiving device to which payload data is to be sent. In this manner, the 32-bit address to be stored in the first row 506 operates as a header pointer 528. In the example second configuration, the second row 508 is to store a 32-bit address that operates as the buffer pointer 524. In the example second configuration, the main processor circuitry with which the NIC operates may set the header of the receiving device from a central location whereas in the example first configuration, the main processor circuitry may set the header by editing the header information in the payload buffer 522.

In some examples, one or more bits (e.g., one or more context bits) in a reserved field of the descriptor 504 may indicate a context of the descriptor 504. The one or more context bits indicate whether the header of the receiving device will be the same for a certain number (e.g., n) of payloads to be sent by the NIC. If the one or more context bits indicate the header will be consistent for the next n payloads, the NIC may not read the header information for the next n payloads but instead, store the header information for a first payload of the next n payloads and refer to the stored header information until after the next n payloads have been transmitted by the NIC.

In the illustrated example of FIG. 5, the third row 510 is to store an example buffer length field 530 and example header length field 532. In the example of FIG. 5, the buffer length field 530 is a 16-bit field and the header length field 532 is a 16-bit field. In additional or alternative examples, the bitlength of the buffer length field 530 and the header length field 532 may be different. The example buffer length field 530 specifies the size of the data (e.g., payload data and/or header data) stored in the payload buffer 522. The example header length field 532 specifies the size of the header data 526 stored at the address pointed to by the header pointer 528. In the example first configuration of the descriptor 504, the header length field 532 may be omitted.

In the illustrated example of FIG. 5, the fourth row 512 is to store an example frame/payload length field 534 and other fields. In the example of FIG. 5, the frame/payload length field 534 is a 16-bit field and the other fields are 16 bits in length. In additional or alternative examples, the bitlength of the frame/payload length field 534 and the other fields may be different. The example frame/payload length field 534 specifies the data size (e.g., 1 kilobyte (KB), 0.5 KB, etc.) of packets that are to be sent to transmit the entirety of a payload stored in the payload buffer 522. For example, payload data stored in the payload buffer 522 may be larger than the packet size permitted by a standard (e.g., a TSN standard). As such, the frame/payload length field 534 specifies the packet size the NIC is to use to send one or more packets comprising the payload. For example, if a payload is 3 KB and the frame/payload length field 534 specifies a packet size of 1 KB, then the NIC will transmit three packets include 1 KB of data from the payload.

In the illustrated example of FIG. 5, the fifth row 514 is to store an example launch time field 536. In the example of FIG. 5, the launch time field 536 is a 32-bit field. In additional or alternative examples, the bitlength of the launch time field 536 may be different. The example launch time field 536 specifies the time at which the payload data stored in the payload buffer 522 should be sent to a receiving device. In some examples, the time at which the payload data is to be sent may be offset from a current time of an internal clock of the NIC.

In the illustrated example of FIG. 5, the sixth row 516 is a 32-bit field and the seventh row 518 is a 32-bit field. In the example of FIG. 5, the sixth row 516 and the seventh row 518 are reserved to store data (e.g., data related to the descriptor 504 and/or payload stored in the payload buffer 522). The 32 available bits in the sixth row 516 and/or the seventh row 518 may be divided in any manner. In the example of FIG. 5, the eighth row 520 is a 32-bit field. In the example of FIG. 5, 31 bits of the eighth row 520 are reserved to store data (e.g., data related to the descriptor 504 and/or payload stored in the payload buffer 522) and 1 bit of the eighth row 520 is an example control bit 538. The 31 available bits in the eighth row 520 may be divided in any manner. The example control bit 538 specifies which device (e.g., the main processor circuitry or the NIC) can write to the descriptor 504. For example, when the control bit 538 is set to zero (e.g., control bit=0), the main processor circuitry may write to the descriptor 504 and the NIC may not write to the descriptor 504. Additionally, for example, when the control bit 538 is set to one (e.g., control bit=1), the main processor circuitry may not write to the descriptor 504 and the NIC may write to the descriptor 504.

In the example of FIG. 5, the shared memory 502 may be divided into one or more descriptor rings and one or more payload buffer rings. For example, a ring refers to a circular buffer operating on a first in, first out (FIFO) basis including a head pointer pointing to a current element of the buffer (e.g., the next element after the most recently written element) and a tail pointer pointing to the oldest written element of the buffer (e.g., the element to be written first to the buffer).

TSN NICs precisely schedule data packets based on available IEEE standard scheduling algorithms and precisely generate timestamps for the data packets with sub-nanosecond accuracy. TSN NICs then report the timestamps to one or more applications executing on main processor circuitry (e.g., a CPU). In a first type of existing TSN NIC, after a packet is transmitted by the NIC, the NIC records the timestamp at which a packet was sent in the memory location of a corresponding descriptor of the packet. Additionally, in the first type of existing TSN NIC, after a packet is received by the NIC, the NIC records the timestamp at which a packet was received in the memory location of a corresponding descriptor of the packet.

For example, in TSN NICs, when an application executing on main processor circuitry advances the tail pointer of a descriptor ring with updated (e.g., fresh) data by setting the control bit of a descriptor (e.g., setting the control bit to one), the TSN NIC takes control over the descriptor and its processing. In TSN NICs, DMA control circuitry fetches the descriptor from shared memory. After parsing the descriptor, the DMA control circuitry initiates an upstream read operation to fetch the payload from the shared memory (e.g., DDR) and pushes the payload into a queue of a data cache of the TSN NIC that corresponds to the traffic class of the payload. As used herein the term upstream refers to an operation where a NIC makes a request to shared memory. As used herein the term downstream refers to an operation where main processor circuitry makes a request to read data from the NIC.

MAC circuitry of TSN NICs schedules the launch time of the payload according to a scheduling algorithm. To satisfy the scheduled launch time, the MAC circuitry fetches the payload from the data cache, formats the payload into a packet (e.g., packetizes the payload), and causes transmission of the packet. To packetize a payload, the MAC circuitry formats the payload according to a standard (e.g., the IEEE 802.1Q standard, the “IEEE Standard for Ethernet,” in IEEE Std 802.3-2018 (Revision of IEEE Std 802.3-2015), vol., no., pp. 1-5600, 31 Aug. 2018 (referred to hereinafter as “the IEEE 802.3 standard”), etc.) where the packet typically includes a preamble having a start frame delimiter (SFD) field, a destination MAC address, a source MAC address, among others.

The MAC circuitry precisely timestamps the packet when the SFD crosses an interface (e.g., a 10-gigabit media-independent interface (XGMII), a gigabit media-independent interface (GMII), a media-independent interface (MII)) boundary and is passed to and/or received from physical layer (PHY) circuitry. Such PHY circuitry may be implemented by a transmitter, a receiver, and/or a transceiver. PHY circuitry is typically implemented outside of an SoC on the same printed circuitry board (PCB) as the SoC but in a separate package from the SoC. In the first type of existing TSN NICs, once the MAC circuitry generates the timestamp (e.g., the packet is transmitted), the MAC circuitry sends the timestamp and status information to the DMA control circuitry. The DMA control circuitry of the first type of existing TSN NICs then writes the timestamp and status information into the same descriptor by overwriting some of the fields of the descriptor (e.g., existing DMA control circuitry writes the timestamp to the first row 506 and/or the second row 508 and writes the status to the eighth row 520) that are no longer needed by the MAC circuitry (e.g., the data has already been consumed by the MAC circuitry). The MAC circuitry of the first type of existing TSN NICs then releases the descriptor back to the application executing on the main processor circuitry by clearing the control bit (e.g., resetting the control bit to zero) and generates an interrupt to the application to indicate that the packet has been transmitted and that the descriptor may be overwritten by the application executing on the main processor circuitry.

The first type of existing TSN NICs face at least two bottlenecks in packet processing. The first bottleneck is caused because the descriptor is not released (e.g., the control bit remains set to one) until the packet is transmitted. As such, the application executing on the main processor circuitry may not overwrite descriptors in the descriptor ring until corresponding packets are transmitted. Because packets and descriptors are prefetched by TSN NICs ahead of time this delay causes a significant bottleneck. The second bottleneck is caused by the hardware of the first type of existing TSN NICs. For example, the descriptor stored in a descriptor cache of the TSN NIC is not released until the packet is transferred to the queue corresponding to the traffic class of the packet despite the payload data having already been fetched from shared memory. The second bottleneck is caused because the DMA control circuitry of the first type of existing TSN NICs must keep the address in shared memory where the descriptor is stored so that the DMA control circuitry may write the packet timestamp and status at later time once the packet is transmitted. In other words, because the DMA control circuitry maintains the descriptor and the address to which the timestamp and status are to be written in the same cache (e.g., the descriptor cache), the DMA control circuitry cannot release the descriptor (e.g., cannot set the control bit to zero) until after the timestamp is generated.

The first type of existing TSN NICs is sufficient for lower line rates (e.g., 2.5 gigabit per second (Gbps), 1 Gbps, etc.). For example, in existing TSN NICs of the first type that operate at 1 Gbps line rate, the descriptor cache typically occupies less than 2 KB of memory and does not significantly impact silicon area. However, at higher line rates (e.g., greater than 2.5 Gbps, 10 Gbps, etc.), the first type of existing TSN NICs is subject to severe limitation on the effective transmit bandwidth of a TSN NIC and/or the silicon area required to implement the TSN NIC. Many of the disadvantages that existing TSN NICs suffer from result from the related operations on timestamp and status information by both the TSN NIC and main processor circuitry. For example, as the line rate of existing TSN NICs increases, the delays associated with closing descriptors creates backpressure and stalling which leads to lower effective bandwidth. Many of the disadvantages that existing TSN NICs suffer result from the related operations on timestamp and status information by both the TSN NIC and main processor circuitry. For example, as the line rate of existing TSN NICs increases, the delays associated with closing descriptors creates backpressure and stalling which leads to lower effective bandwidth.

To configure the first type of existing TSN NICs to operate at higher line rates, it is necessary to increase the size of the descriptor ring in shared memory, the size of the descriptor cache on the TSN NIC, and the size of the non-posted request and completion credit memory (discussed further herein) on the TSN NIC. Because the first type of existing TSN NICs do not close descriptors after fetching the payload data, but instead after the payload data is sent, the first type of existing TSN NICs (e.g., implemented in data centers) require a very large descriptor cache to meet higher line rates. For example, because each descriptor requires 32 bytes of memory, the first type of existing TSN NICs requires up to 12 KB of descriptor cache to operate at 10 Gbps. Such large cache sizes are untenable for edge computing applications, such as IoT applications and other cost sensitive applications.

A second type of existing TSN NICs do not track the transmit status. Instead, the MAC circuitry of the second type of existing TSN NICs releases descriptors as soon as the payload data is fetched from the memory but without waiting for the payload data to be transmitted. The second type of existing TSN NICs no longer track when a payload is transmitted or the status of the payload. As the status of the payload transmission is dropped in existing TSN NICs of the second type, applications executing on the main processor circuitry has no insight as to when the payload is transmitted or if the payload was transmitted without any errors. The payload timestamps and the payload status are very critical for hard real-time applications. Knowing only that a payload has been transmitted is not enough for applications executing on main processor circuitry. To operate effectively such applications executing on main processor circuitry should know precisely when the payload is precisely transmitted and the status of the payload. As such, the second type of existing TSN NICs fail to satisfy the requirements of TSN standards.

A third type of existing TSN NICs does not write the payload transmit status or the timestamp to the descriptor in the descriptor cache of the TSN NIC or in the shared memory, but instead maintains the payload transmit status and the timestamp in a 16-element cache (e.g., a timestamp/status cache) local to the third type of existing TSN NICs where each element is 64-bits in length. The timestamp/status cache local to the third type of existing TSN NICs operates as a FIFO cache. In the third type of existing TSN NICs, the DMA control circuitry releases a descriptor as soon as the DMA control circuitry fetches the payload data from the shared memory and the data is pushed to a corresponding queue of the data cache but does not wait for the payload data to be transmitted. After the timestamps and status are written to the local timestamp/status cache, an application executing on the main processor circuitry can access the timestamps and status of transmitted payloads by reading the local timestamp/status cache. In the third type of existing TSN NICs, the descriptor cache can be decreased by half (e.g., to 1 KB). However, a disadvantage of the third type of existing TSN NICs is that the application executing on main processor circuitry must read the local timestamp/status cache very quickly or the application will run the risk of losing timestamps and/or statuses of some payloads that are overwritten according to the FIFO storage format.

Additionally, in the third type of existing TSN NICs, each downstream memory-mapped input output (I/O) (MMIO) read operation takes about 2 microseconds (μs). As such, at a 10 Gbps line rate, in the third type of existing TSN NICs update the 64-byte status field at the rate of 67.2 nanoseconds (ns). Due to the quick refresh rate for the local timestamp/status cache, the third type of existing TSN NICs must implement a very large local timestamp/status cache to prevent data from being overwritten before the application executing on main processor circuitry can read such data. As such, to operate at higher line rates, the third type of existing TSN NICs requires a large silicon area.

Example methods, apparatus, and articles of manufacture disclosed herein decouple the operation writing payload timestamps and status to shared memory from the operation releasing descriptors (e.g., setting the control bit to zero). Example descriptors disclosed herein include a writeback address pointer that points to a location in shared memory to which the memory access control circuitry (e.g., DMA control circuitry) is to write timestamps and/or status of transmitted packets rather than writing the timestamps and/or status directly to the location of the descriptors in the shared memory.

As such, memory access control circuitry disclosed herein closes disclosed descriptors (e.g., by setting the control bit to zero) as soon as disclosed memory access control circuitry fetches the payload data to be transmitted without waiting for the packet to be transmitted. Accordingly, examples disclosed herein reduce backpressure and stalling and therefore allow example applications executing on main processor circuitry to overwrite descriptors (e.g., to advance the tail pointer of an example descriptor ring) with updated (e.g., fresh) data more quickly and without waiting for disclosed NICs to release the descriptors after transmission of packets. Such improvements achieved by disclosed examples increase the effective utilization of bandwidth in NICs. Additionally, examples disclosed herein are very area efficient as disclosed NICs store writeback address pointers (e.g., 8 bytes) instead of entire descriptors (e.g., 32 bytes). Also, examples disclosed herein reduce the amount of total descriptor cache as compared to existing NICs by half. Unlike some existing TSN NICs, examples disclosed herein do not need to increase storage for non-posted and completion credits that is otherwise required due to backpressure suffered by the configuration of those existing TSN NICs. Improvements achieved by disclosed methods, apparatus, and articles of manufacture are further magnified when examples disclosed herein are implemented in NICs operating at high speeds.

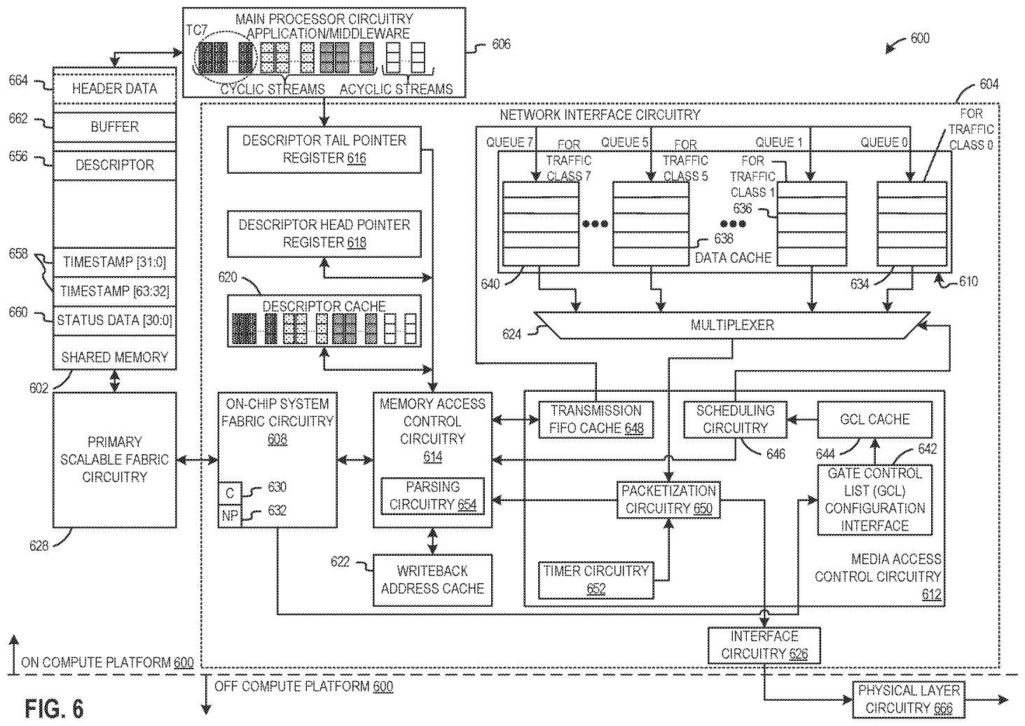

FIG. 6 is a block diagram of an example compute platform 600 including an example shared memory 602, example network interface circuitry (NIC) 604, and example main processor circuitry 606. In the example of FIG. 6, the compute platform 600 may be implemented as a part of one or more edge devices and/or one or more IT/OT devices of FIGS. 1, 2, 3, and/or 4. Additionally or alternatively, the compute platform 600 may be implemented as an SoC. The shared memory 602 of the example of FIG. 6 is accessible by both the NIC 604 and the main processor circuitry 606. In the example of FIG. 6, the shared memory 602 is implemented by one or more DDR memories, such as DDR, DDR2, DDR3, DDR4, DDR5, mDDR, DDR SDRAM, etc. The example shared memory 602 of FIG. 6 is implemented in the same package as the NIC 604 and the main processor circuitry 606, but on a different die than the NIC 604 and/or the main processor circuitry 606 (e.g., separate chiplets). In some examples, the shared memory 602 may be implemented by a volatile memory (e.g., SRAM, SDRAM, DRAM, RDRAM, etc.) and/or a non-volatile memory (e.g., flash memory). For example, if the shared memory 602 is implemented as SRAM, the shared memory 602 may be implemented on the same die as the NIC 604 and/or the same die as the main processor circuitry 606.

In some examples, the shared memory 602 may be implemented by one or more mass storage devices such as HDD(s), CD drive(s), DVD drive(s), SSD drive(s), SD card(s), CF card(s), etc. While in the illustrated example the shared memory 602 is illustrated as a single memory, the shared memory 602 may be implemented by any number and/or type(s) of memories. Furthermore, the data stored in the shared memory 602 may be in any data format such as, for example, binary data, comma delimited data, tab delimited data, SQL structures, etc. In the example of FIG. 6, the shared memory 602 may be divided into one or more descriptor rings and one or more payload buffer rings.

In the illustrated example of FIG. 6, the NIC 604 includes example on-chip system fabric (OSF) circuitry 608, example data cache 610, example media access control (MAC) circuitry 612, example memory access control circuitry 614, an example descriptor tail pointer register 616, an example descriptor head pointer register 618, example descriptor cache 620, example writeback address cache 622, an example multiplexer 624, and example interface circuitry 626. The NIC 604 of FIG. 6 may be instantiated (e.g., creating an instance of, bring into being for any length of time, materialize, implement, etc.) by an ASIC or an FPGA structured to perform operations corresponding to the instructions (e.g., corresponding to instructions). In some examples, an ASIC is referred to as Application Specific Integrated Circuitry. Additionally or alternatively, the NIC 604 of FIG. 6 may be instantiated (e.g., creating an instance of, bring into being for any length of time, materialize, implement, etc.) by processor circuitry such as a central processing unit executing instructions. It should be understood that some or all of the circuitry of FIG. 6 may, thus, be instantiated at the same or different times. Some or all of the circuitry may be instantiated, for example, in one or more threads executing concurrently on hardware and/or in series on hardware. Moreover, in some examples, some or all of the circuitry of FIG. 6 may be implemented by one or more virtual machines and/or containers executing on the microprocessor.

In the illustrated example of FIG. 6, the OSF circuitry 608 is implemented by one or more hardware switches that have been virtualized into one or more logical switches. In the example of FIG. 6, the OSF circuitry 608 serves as an interface between example primary scalable fabric (PSF) circuitry 628 that couples the NIC 604 to other portions of the compute platform 600, such as the shared memory 602. The example OSF circuitry 608 transmits one or more completion signals to and/or receives one or more request signals from the memory access control circuitry 614. In the example of FIG. 6, request signals correspond to requests for the MAC circuitry 612, made via the memory access control circuitry 614, to prefetch data from the shared memory 602 and completion signals correspond to a return of the prefetched data to the memory access control circuitry 614.

In the illustrated example of FIG. 6, the OSF circuitry 608 maintains a local memory to store example completion credits 630 and example non-posted request credits 632. In response to the MAC circuitry 612 transmitting a request signal, via the memory access control circuitry 614, to the OSF circuitry 608, the OSF circuitry 608 adjusts the non-posted request credits 632. Additionally, in response to the memory access control circuitry 614 receiving requested data, the OSF circuitry 608 adjusts the completion credits 630. Example completion and request signals are routed based on one or more virtual classes (VCs) and corresponding one or more traffic classes (TCs) assigned to data streams. For example, the IEEE 802.1Q standard defines eight traffic classes to which a data stream must map. In examples disclosed herein, time sensitive hard real-time data streams are mapped to TC7-TC5 and best effort data streams are mapped to TC4-TC0.

In the illustrated example of FIG. 6, memory in the example data cache 610 is allocated to queues of the data cache 610 based on the traffic class of data streams that are mapped to respective queues. For example, the data cache 610 includes eight queues of which an example first queue 634, an example second queue 636, an example sixth queue 638, and an example eighth queue 640 are illustrated. In the example of FIG. 6, TC0 is mapped to the first queue 634, TC1 is mapped to the second queue 636, TC5 is mapped to the sixth queue 638, and TC7 is mapped to the eighth queue 640. In the illustrated example of FIG. 6, the OSF circuitry 608 serves as an interface for applications executing on the main processor circuitry 606 to specify, to the MAC circuitry 612, which queues of the data cache 610 are to be transmitted at which times and for how long. For example, an application may specify, ahead of time, that data from the queue dedicated to TC7 is to be transmitted starting at 5 PM for 60 minutes. In the example of FIG. 6, the data cache 610 is implemented by 32 KB of cache.

In the illustrated example of FIG. 6, the MAC circuitry 612 is implemented by one or more logic circuits. In additional or alternative examples, the MAC circuitry 612 is implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. In the example of FIG. 6, the MAC circuitry 612 includes an example gate control list (GCL) configuration interface 642, example gate control list (GCL) cache 644, example scheduling circuitry 646, example transmission first in, first out (FIFO) cache 648, example packetization circuitry 650, and example timer circuitry 652.

In the illustrated example of FIG. 6, the GCL configuration interface 642 is implemented as a memory-mapped register that allows an application executing on the main processor circuitry 606 to write to the GCL cache 644. For example, an application executing on the main processor circuitry 606 may specify, ahead of time, which queues of the data cache 610 are to be transmitted at which times and for how long by writing to the GCL cache 644 via the GCL configuration interface 642. The scheduling circuitry 646 transmits a request signal (e.g., initiates a request) to the memory access control circuitry 614 to prefetch data to be transmitted.

In the illustrated example of FIG. 6, the memory access control circuitry 614 is implemented by one or more logic circuits. In additional or alternative examples, the memory access control circuitry 614 is implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. In the example of FIG. 6, the memory access control circuitry 614 includes example parsing circuitry 654. In the example of FIG. 6, when an application executed by the main processor circuitry 606 advances the tail pointer of a descriptor ring in the shared memory 602 with updated (e.g., fresh) data by setting the control bit of a descriptor, the NIC 604 takes over control of the descriptor. To determine the current position in the descriptor ring, the memory access control circuitry 614 references the descriptor tail pointer register 616 and the descriptor head pointer register 618. The descriptor tail pointer register 616 may be set by the application executed by the main processor circuitry 606 and the descriptor head pointer register 618 is maintained by the memory access control circuitry 614.

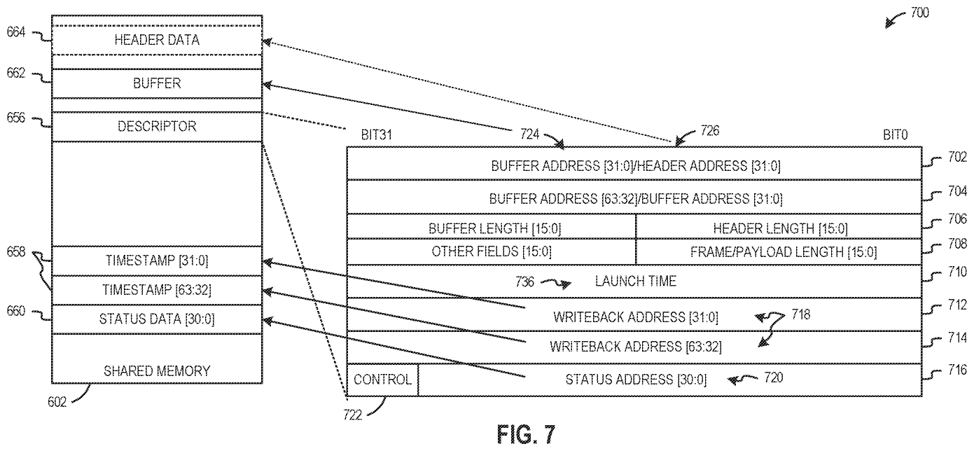

In the illustrated example of FIG. 6, the example memory access control circuitry 614 fetches an example descriptor 656 from the shared memory 602 based on the descriptor head pointer stored in the descriptor head pointer register 618. As described above, the descriptor 656 corresponds to data (e.g., is a descriptor of data) to be transmitted to a second device. Accordingly, the descriptor 656 is associated with data (e.g., payload data) to be transmitted to a second device. Subsequently, the memory access control circuitry 614 loads the descriptor 656 into the descriptor cache 620 (e.g., L1, L2, L3, etc.). In the example of FIG. 6, the descriptor cache 620 is implemented by 4 KB of cache. FIG. 7 illustrates an example block diagram 700 of the example shared memory 602 of the compute platform 600 of FIG. 6. In the example of FIG. 7, the example descriptor 656 is a data structure including eight rows (an example first row 702, an example second row 704, an example third row 706, an example fourth row 708, an example fifth row 710, an example sixth row 712, an example seventh row 714, and an example eighth row 716) where each row is 32 bits wide. The format of the descriptor 656 may be made available in product publications so that consumers are aware of the format.

In the illustrated example of FIG. 7, the descriptor 656 is substantially similar to the descriptor 504 of FIG. 5. For example, the sixth row 712 of the descriptor 656 is a 32-bit field and the seventh row 714 of the descriptor 656 is a 32-bit field. Different from the descriptor 504, however, the sixth row 712 and the seventh row 714 are to store a 64-bit address (e.g., 32 bits are to be stored in the sixth row 712 and 32 bits are to be stored in the seventh row 714) that points to a location in the shared memory 602 where an example timestamp 658 indicative of a time at which a corresponding packet was sent is to be stored. In this manner, the 64-bit address operates as an example writeback address pointer 718 corresponding to the descriptor 656. Thus, the writeback address pointer 718 is indicative of an address in the shared memory 602 where the timestamp 658 is to be stored. As such the writeback address pointer 718 points to a first addresses in the shared memory 602 that is different from a second address in the shared memory 602 where the descriptor 656 is stored.

Additionally, in the illustrated example of FIG. 7, the eighth row 716 is a 32-bit field. In the example of FIG. 7, 31 bits of the eighth row 716 are to store a 31-bit address that points to a location in the shared memory 602 where example status data 660 indicative of a status of the packet that was sent. In this manner, the 31-bit address to be stored in the eighth row 716 operates as an example status pointer 720 corresponding to the descriptor 656. Thus, the status pointer 720 is indicative of an address in the shared memory 602 where the status data 660 is to be stored. As such the status pointer 720 points to a first addresses in the shared memory 602 that is different from a second address in the shared memory 602 where the descriptor 656 is stored. Additionally, 1 bit of the eighth row 716 is an example control bit 722. The example control bit 722 specifies which device (e.g., the main processor circuitry 606 or the NIC 604) can write to the descriptor 656. In some examples, driver instructions that allow the main processor circuitry 606 to interface with the NIC 604 are updated to accommodate the addition of the writeback address pointer 718 and the status pointer 720.

The example of FIG. 7 illustrates one implementation of the descriptor 656. For example, the format of the descriptor 656 of the example of FIG. 7 is designed by a vendor of the NIC 604. In additional or alternative examples, a descriptor may include more information (e.g., more data) or less information (e.g., less data) than the descriptor 656 of the example FIG. 7 depending on the vendor of the NIC with which the descriptor is used. In some examples, a descriptor may include more information (e.g., more data) or less information (e.g., less data) than the descriptor 656 of the example FIG. 7 depending on a standard with which the descriptor complies. NICs may still take advantage of examples disclosed herein if descriptors include one or more fields for the writeback address pointer 718 and/or the status pointer 720.

Returning to the illustrated example of FIG. 6, the parsing circuitry 654 of the memory access control circuitry 614 parses the descriptor 656 to identify an example buffer pointer 724 stored in the first row 702 and/or the second row 704 of the descriptor 656. For example, the parsing circuitry 654 parses the descriptor 656 by converting data from one format to another format. As described above, the buffer pointer 724 is indicative of an address in the shared memory 602 of an example payload buffer 662 of payload data. In some examples, the parsing circuitry 654 additionally parses the descriptor 656 to identify an example header pointer 726 stored in the first row 702 of the descriptor 656. As described above, the header pointer 726 is indicative of an address in the shared memory 602 where example header data 664 is stored.

In the illustrated example of FIG. 6, the example parsing circuitry 654 additionally parses the descriptor 656 to identify (1) the writeback address pointer 718 stored in the sixth row 712 and the seventh row 714 of the descriptor 656 and (2) the status pointer 720 stored in the eighth row 716 of the descriptor 656. In the example of FIG. 6, the parsing circuitry 654 parses the descriptor 656 based on a mapping of the descriptor 656 stored on the NIC 604. For example, the parsing circuitry 654 may parse the descriptor 656 by referencing the format of the descriptor 656. In this manner, the parsing circuitry 654 identifies which rows of the descriptor 656 include which data. Based on the identification of respective rows of the descriptor 656, the parsing circuitry 654 may extract the bits stored in each row of the descriptor 656. The example memory access control circuitry 614 of FIG. 6 generates an upstream read request based on the buffer pointer 724 and/or the header pointer 726 to retrieve payload data stored in the payloads buffer 662.

In the illustrated example of FIG. 6, the memory access control circuitry 614 additionally causes storage (e.g., is to cause storage) of the writeback address pointer 718 and the status pointer 720 in the writeback address cache 622 (e.g., L1, L2, L3, etc.) according to an indexing mechanism. For example, the memory access control circuitry 614 is to cause the writeback address cache 622 to perform the act of storing the writeback address pointer 718 and the status pointer 720. The writeback address cache 622 of the example of FIG. 6 is local to the NIC 604 and separate from the shared memory 602 and other memory of the NIC 604. In some examples, the writeback address cache 622 may be identifiable through visible inspection and/or via a scanning electron microscope (SEM) and/or a transmission electron microscope (TEM).

In the illustrated example of FIG. 6, the memory access control circuitry 614 generates indices for data to be stored in the writeback address cache 622 based on (1) a queue of the data cache 610 to which payload data associated with a descriptor corresponds and (2) a position of the payload data in that queue. For example, the parsing circuitry 654 generates indices for data to be stored in the writeback address cache 622 based on (1) a queue of the data cache 610 to which payload data associated with a descriptor corresponds and (2) a position of the payload data in that queue. In this manner, the parsing circuitry 654 acts as a decoder by converting binary data representative of the writeback address pointer 718 and the status pointer 720 into indexed binary data that is tagged with (e.g., indexed according to) an identifier of the data to which the writeback address pointer 718 and the status pointer 720 correspond.

As described above, each queue of the example data cache 610 corresponds to a traffic class of the data stored in that queue. For example, the queue to which payload data associated with a descriptor corresponds is representative of a channel number of the memory access control circuitry 614. In some examples, the channel numbers of the memory access control circuitry 614 are programmed ahead of time (e.g., by the MAC circuitry 612). Additionally, for example, the index of the payload data in that queue is representative of a transaction identifier (ID) of the payload data. In some examples, the transaction ID starts at zero and is incremented corresponding to the number of descriptors for a channel.

In the illustrated example of FIG. 6, the index of the writeback address pointer 718 and the status pointer 720 is implemented as a 16-bit value where 3 bits specify the queue and 13 bits specify the index of the writeback address pointer 718 and the status pointer 720 in the queue. Other configurations of the index are possible. In this manner, the writeback address cache 622 is to store the writeback address pointer 718 and the status pointer 720 (e.g., the writeback address cache 622 is a cache to store one or more pointers). In the example of FIG. 6, the writeback address cache 622 is implemented by 1 KB of cache. In some examples, the writeback address cache 622 implements one or more timestamp buffer rings and/or one or more status buffer rings.

In the illustrated example of FIG. 6, after storage of the writeback address pointer 718 and the status pointer 720 in the writeback address cache 622, the memory access control circuitry 614 pushes the payload data retrieved from the shared memory 602 and the index of the payload data to the transmission FIFO cache 648 to be stored in the data cache 610 (e.g., L1, L2, L3, etc.). As such the payload data retrieved from the shared memory 602 has been converted (e.g., by the parsing circuitry 654) from one format (e.g., raw payload data) to another format (e.g., indexed payload data). According to the FIFO configuration and based on index received from the memory access control circuitry 614, the transmission FIFO cache 648 loads data into the data cache 610. The memory access control circuitry 614 then generates an upstream write transaction to close the descriptor 656 (e.g., by setting the control bit 722 to zero). As described above, by setting the control bit 722 of the descriptor 656, the memory access control circuitry 614 relinquishes control over the descriptor 656. In this manner, the memory access control circuitry 614 sets the control bit 722 of the descriptor 656 to indicate that the descriptor 656 may be overwritten by an application executing on the main processor circuitry 606. As such, the memory access control circuitry 614 sets the control bit 722 of the descriptor 656 in response to forwarding the payload data to the MAC circuitry 612 (e.g., the transmission FIFO cache 648). The memory access control circuitry 614 then flushes the descriptor 656 from the descriptor cache 620. As such, because the writeback address pointer 718 and the status pointer 720 are stored in a separate local cache (e.g., the writeback address cache 622), the memory access control circuitry 614 can flush (e.g., delete) the descriptor 656 from the descriptor cache 620 as soon as the payload data is fetched. As such, the descriptor cache 620 can be emptied quickly compared to existing techniques which allowed for the size of the descriptor cache 620 to be reduced as compared to existing techniques. Accordingly, examples disclosed herein decouple descriptors from actual packet transmission.

In the illustrated example of FIG. 6, the scheduling circuitry 646 schedules transmissions based on the information stored in the GCL cache 644 and/or depending on various criteria such as that specified by the “IEEE Standard for Local and metropolitan area networks—Bridges and Bridged Networks—Amendment 25: Enhancements for Scheduled Traffic,” in IEEE Std 802.1Qbv-2015 (Amendment to IEEE Std 802.1Q-2014 as amended by IEEE Std 802.1Qca-2015, IEEE Std 802.1Qcd-2015, and IEEE Std 802.1Q-2014/Cor 1-2015), vol., no., pp. 1-57, 18 Mar. 2016 (referred to hereinafter as “the IEEE 802.1Qbv standard”) and/or the “IEEE Standard for Local and Metropolitan Area Networks—Virtual Bridged Local Area Networks Amendment 12: Forwarding and Queuing Enhancements for Time-Sensitive Streams,” in IEEE Std 802.1Qav-2009 (Amendment to IEEE Std 802.1Q-2005), vol., no., pp. C1-72, 5 Jan. 2010 (referred to hereinafter as “the IEEE 802.1Qav standard”). For example, the scheduling circuitry 646 schedules transmissions based on the traffic class priority, launch time specified in the GCL cache 644 (e.g., for the IEEE 802.1Qbv standard), in the descriptor (e.g., for time-based scheduling), the available credits (e.g., for the IEEE 802.1Qav standard) and/or based on the available cache space. Based on a computed schedule, the scheduling circuitry 646 selects a queue of the data cache 610 by setting a control signal of the multiplexer 624.

In the illustrated example of FIG. 6, the packetization circuitry 650 receives payload data from a queue of the data cache 610 selected by the scheduling circuitry 646. The packetization circuitry 650 formats the payload data into a packet (e.g., packetizes the payload data) according to a standard (e.g., the IEEE 802.3 standard). For example, packetized payload data includes a preamble having an SFD field, a destination MAC address, a source MAC address. The packetization circuitry 650 forwards the packetized payload data (e.g., a packet) to the interface circuitry 626.

In the illustrated example of FIG. 6, the interface circuitry 626 is implemented by a media-independent interface. For example, the interface circuitry 626 may be implemented by an XGMII, a GMII, an MI. In the example of FIG. 6, when the SFD of the packet crosses the boundary of the interface circuitry 626, the timer circuitry 652 generates a timestamp (e.g., the timestamp 658) and provides the timestamp to the packetization circuitry 650. In the example of FIG. 6, the timer circuitry 652 is implemented by a precision time protocol timer.

In the illustrated example of FIG. 6, after the packet crosses the boundary of the interface circuitry 626, example physical layer (PHY) circuitry 666 transmits the packet to a receiving device (e.g., based on the destination MAC address). The example PHY circuitry 666 may be implemented by a transmitter, a receiver, and/or a transceiver. The PHY circuitry 666 is typically implemented outside the compute platform 600 (e.g., outside an SoC) on the same PCB as the compute platform 600 but in a separate package from the compute platform 600.

In the illustrated example of FIG. 6, the packetization circuitry 650 reports the timestamp (e.g., the timestamp 658) and transmit status (e.g., the status data 660) to the memory access control circuitry 614 indicating that the packet has been transmitted. In response to receiving such an indication, the memory access control circuitry 614 retrieves the writeback address pointer 718 and the status pointer 720 of the corresponding packet from the writeback address cache 622. The memory access control circuitry 614 generates one or more upstream write transactions to the address(es) in the shared memory 602 pointed to by the writeback address pointer 718 and the status pointer 720. As such, the memory access control circuitry 614 causes storage of the timestamp (e.g., the timestamp 658) and the status (e.g., the status data 660) at address(es) in the shared memory 602 indicated by the writeback address pointer 718 and the status pointer 720, respectively. In response to writing the timestamp (e.g., the timestamp 658) and the status (e.g., the status data 660) to the shared memory 602, the memory access control circuitry 614 generates an interrupt to the application executing on the main processor circuitry 606 to indicate that the packet has been transmitted. In some examples, the memory access control circuitry 614 generates the interrupt as soon as the packet is transmitted. In additional or alternative examples, the memory access control circuitry 614 throttles (e.g., delays) interrupts to avoid overburdening an associated application executing on the main processor circuitry 606.

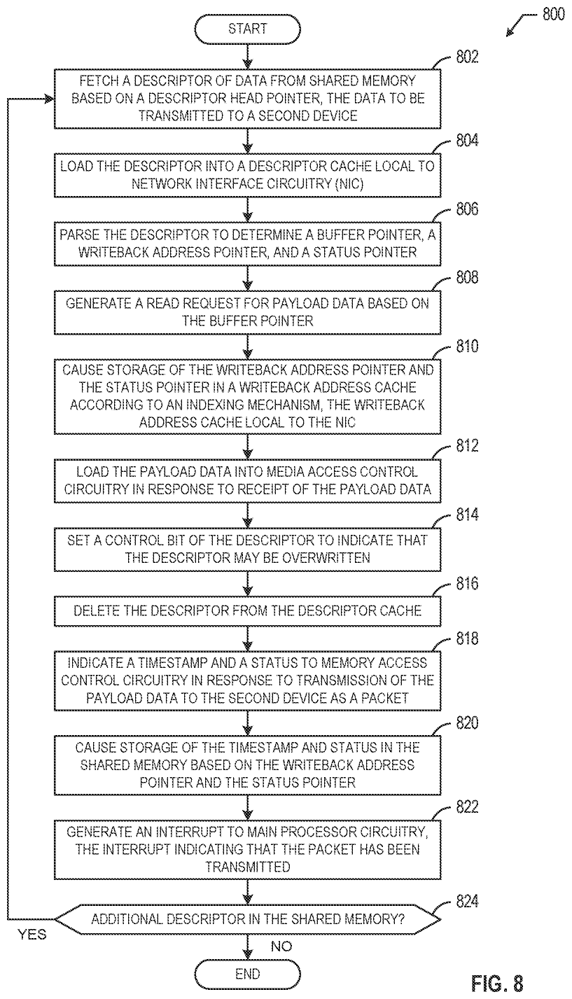

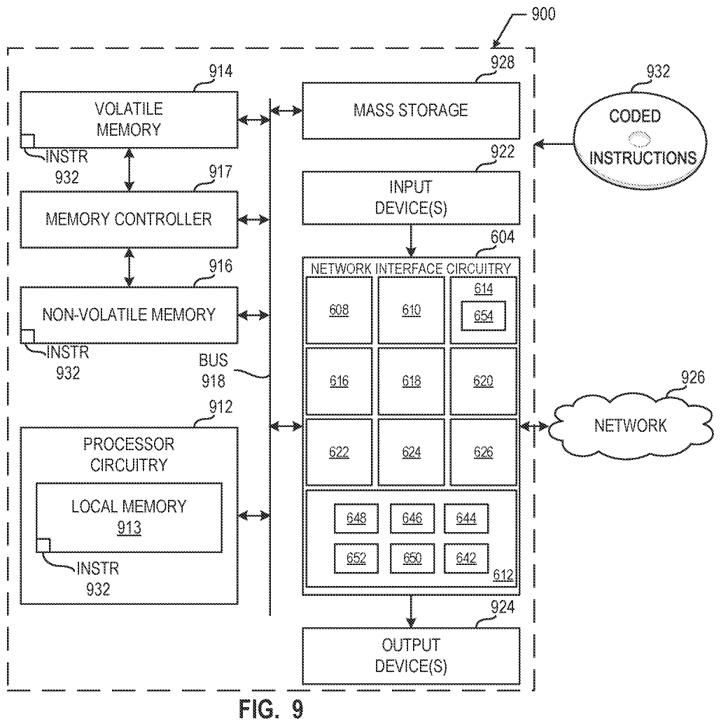

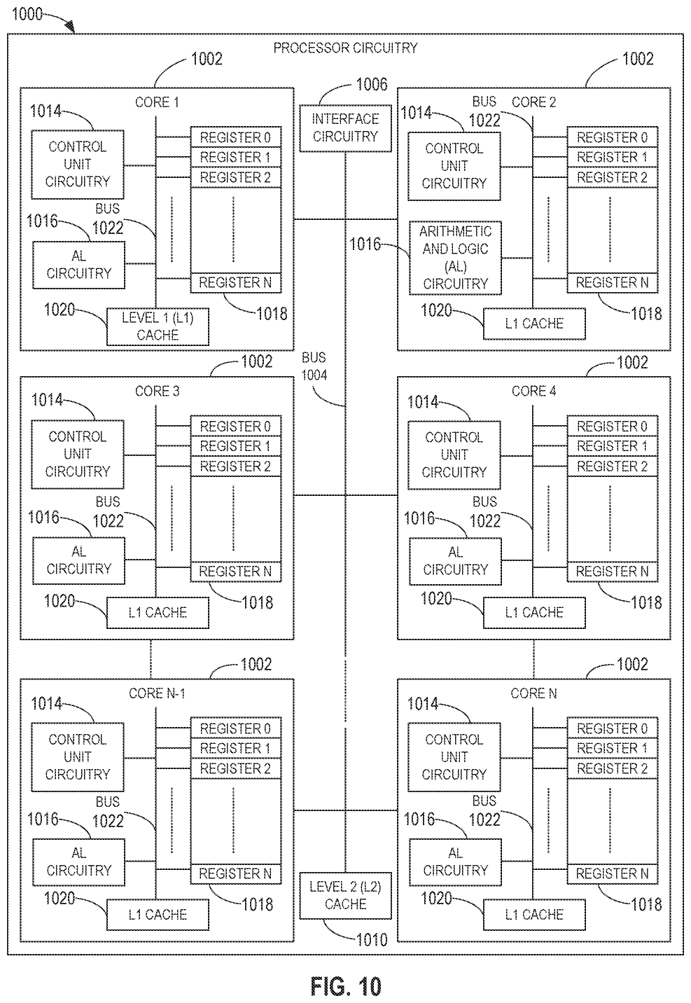

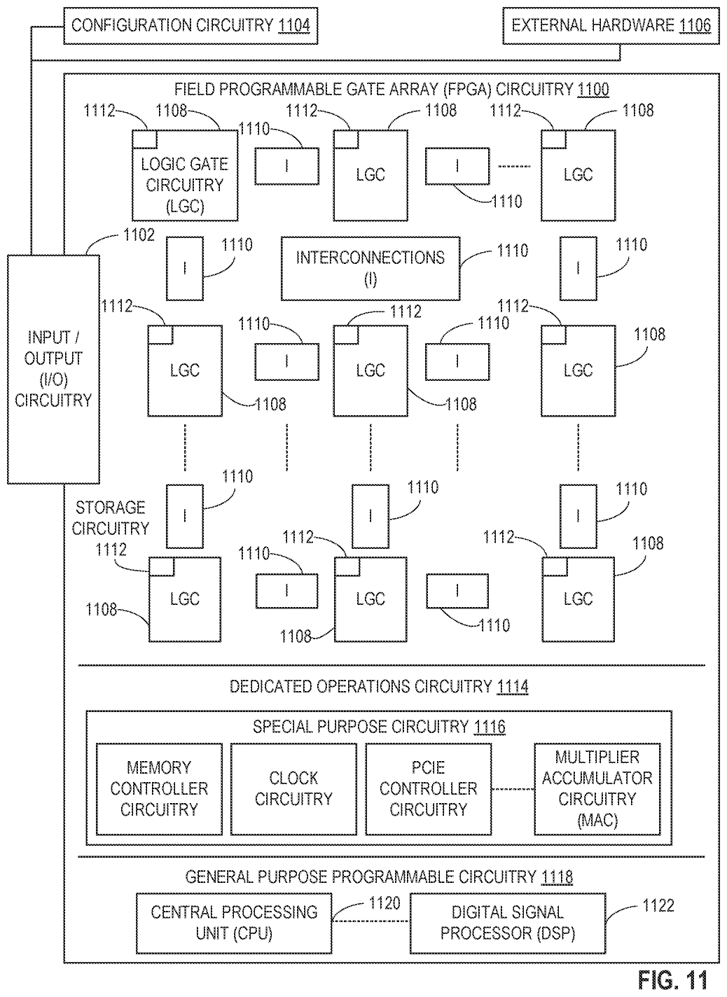

In some examples, the NIC 604 includes means for controlling media access. For example, the means for controlling media access may be implemented by the media access control circuitry 612. In some examples, the media access control circuitry 612 may be instantiated by processor circuitry such as the example processor circuitry 912 of FIG. 9. For instance, the media access control circuitry 612 may be instantiated by the example microprocessor 1000 of FIG. 10 executing machine executable instructions such as that implemented by at least block 818 of FIG. 8. In some examples, the media access control circuitry 612 may be instantiated by hardware logic circuitry, which may be implemented by an ASIC or the FPGA circuitry 1100 of FIG. 11 structured to perform operations corresponding to the machine readable instructions. Additionally or alternatively, the media access control circuitry 612 may be instantiated by any other combination of hardware, software, and/or firmware. For example, the media access control circuitry 612 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the NIC 604 includes means for controlling memory access. For example, the means for controlling memory access may be implemented by the memory access control circuitry 614. In some examples, the memory access control circuitry 614 may be instantiated by processor circuitry such as the example processor circuitry 912 of FIG. 9. For instance, the memory access control circuitry 614 may be instantiated by the example microprocessor 1000 of FIG. 10 executing machine executable instructions such as that implemented by at least blocks 802, 804, 806, 808, 810, 812, 814, 816, 820, 822, and 824 of FIG. 8. In some examples, the memory access control circuitry 614 may be instantiated by hardware logic circuitry, which may be implemented by an ASIC or the FPGA circuitry 1100 of FIG. 11 structured to perform operations corresponding to the machine readable instructions. Additionally or alternatively, the memory access control circuitry 614 may be instantiated by any other combination of hardware, software, and/or firmware. For example, the memory access control circuitry 614 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the NIC 604 includes means for indicating. For example, the means for indicating may be implemented by the packetization circuitry 650. In some examples, the packetization circuitry 650 may be instantiated by processor circuitry such as the example processor circuitry 912 of FIG. 9. For instance, the packetization circuitry 650 may be instantiated by the example microprocessor 1000 of FIG. 10 executing machine executable instructions such as that implemented by at least block 818 of FIG. 8. In some examples, the packetization circuitry 650 may be instantiated by hardware logic circuitry, which may be implemented by an ASIC or the FPGA circuitry 1100 of FIG. 11 structured to perform operations corresponding to the machine readable instructions. Additionally or alternatively, the packetization circuitry 650 may be instantiated by any other combination of hardware, software, and/or firmware. For example, the packetization circuitry 650 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the NIC 604 includes means for parsing. For example, the means for parsing may be implemented by the parsing circuitry 654. In some examples, the parsing circuitry 654 may be instantiated by processor circuitry such as the example processor circuitry 912 of FIG. 9. For instance, the parsing circuitry 654 may be instantiated by the example microprocessor 1000 of FIG. 10 executing machine executable instructions such as that implemented by at least block 806 of FIG. 8. In some examples, the parsing circuitry 654 may be instantiated by hardware logic circuitry, which may be implemented by an ASIC or the FPGA circuitry 1100 of FIG. 11 structured to perform operations corresponding to the machine readable instructions. Additionally or alternatively, the parsing circuitry 654 may be instantiated by any other combination of hardware, software, and/or firmware. For example, the parsing circuitry 654 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the NIC 604 includes one or more means for storing. For example, the one or more means for storing may be implemented by the data cache 610, the descriptor cache 620, and/or the writeback address cache 622. For example, the writeback address cache 622 may implement first means for storing, the data cache 610 may implement second means for storing, and the descriptor cache 620 may implemented third means for storing. In additional or alternative examples, the data cache 610 implements means for storing data, the descriptor cache 620 implements means for storing one or more descriptors, and the writeback address cache 622 implements means for storing one or more writeback address pointers. In some examples, the data cache 610, the descriptor cache 620, and/or the writeback address cache 622 may be implemented by one or more registers, a main memory, a volatile memory (e.g., Static Random Access Memory (SRAM), Status Synchronous Dynamic Random-Access Memory (SDRAM), Dynamic Random-Access Memory (DRAM), RAMBUS® Dynamic Random-Access Memory (RDRAM®), and/or any other type of RAM device), and/or a non-volatile memory (e.g., flash memory and/or any other desired type of memory device).

In some examples, one or more of the shared memory 602, the data cache 610, the descriptor cache 620, or the writeback address cache 622 may be virtualized. For example, one or more memories or other storage media may be aggregated into a virtual memory pool and made available to the NIC 604, the main processor circuitry 606, and/or other compute circuitry by software (e.g., machine readable instructions) and/or hardware circuitry. Such memories or other storage media may be on the same chip as the compute platform 600, on a separate chip outside of the compute platform 600 but on the same device as the compute platform 600, on a separate device from the compute platform 600, among other configurations. Example software includes an application programming interface (API) that allows an application executing on the NIC 604, the main processor circuitry 606, and/or other compute circuitry to access the virtual memory pool. In another example, the software includes an operating system on a compute platform that interfaces between the virtual memory pool and an application executing on the NIC 604, the main processor circuitry 606, and/or other compute circuitry. In some examples, software and/or hardware circuitry utilizes an edge translation table to translate a virtual address in the virtual memory pool to a physical address of physical memory hosted at an edge location. In such examples, the edge translation table maps virtual addresses to physical addresses (e.g., virtual memory mapping).

Additionally, in some examples, one or more of the shared memory 602, the data cache 610, the descriptor cache 620, or the writeback address cache 622 may be referred to a storage circuitry. For example, the shared memory 602 may be referred to as shared storage circuitry, the data cache 610 may be referred to as data storage circuitry, the descriptor cache 620 may be referred to as descriptor storage circuitry, and the writeback address cache 622 may be referred to as writeback address storage circuitry. Storage resources described herein (e.g., non-transitory computer readable medium, non-transitory computer readable storage medium, storage circuitry, memory, cache, etc.) may be implemented by circuitry that is to store information (e.g., the circuitry physically stores that information) or circuitry managing media storing the information where the media includes electronically operated media and non-electronically operated media.

While an example manner of implementing the NIC 604 of FIG. 6 is illustrated in FIG. 6, one or more of the elements, processes, and/or devices illustrated in FIG. 6 may be combined, divided, re-arranged, omitted, eliminated, and/or implemented in any other way. Further, the example on-chip system fabric (OSF) circuitry 608, the example data cache 610, the example media access control (MAC) circuitry 612, the example memory access control circuitry 614, the example descriptor tail pointer register 616, the example descriptor head pointer register 618, the example descriptor cache 620, the example writeback address cache 622, the example multiplexer 624, the example interface circuitry 626, the example gate control list (GCL) configuration interface 642, the example gate control list (GCL) cache 644, the example scheduling circuitry 646, the example transmission first in, first out (FIFO) cache 648, the example packetization circuitry 650, the example timer circuitry 652, the example parsing circuitry 654, and/or, more generally, the example NIC 604 of FIG. 6, may be implemented by hardware alone or by hardware in combination with software and/or firmware. Thus, for example, any of the example on-chip system fabric (OSF) circuitry 608, the example data cache 610, the example media access control (MAC) circuitry 612, the example memory access control circuitry 614, the example descriptor tail pointer register 616, the example descriptor head pointer register 618, the example descriptor cache 620, the example writeback address cache 622, the example multiplexer 624, the example interface circuitry 626, the example gate control list (GCL) configuration interface 642, the example gate control list (GCL) cache 644, the example scheduling circuitry 646, the example transmission first in, first out (FIFO) cache 648, the example packetization circuitry 650, the example timer circuitry 652, the example parsing circuitry 654, and/or, more generally, the example NIC 604 of FIG. 6, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example NIC 604 of FIG. 6 may include one or more elements, processes, and/or devices in addition to, or instead of, those illustrated in FIG. 6, and/or may include more than one of any or all of the illustrated elements, processes, and devices.

A flowchart representative of example hardware logic circuitry, machine readable instructions, hardware implemented state machines, and/or any combination thereof for implementing the NIC 604 of FIG. 6 is shown in FIG. 8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 8, many other methods of implementing the example NIC 604 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or compute devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a compute device and/or other machine. For example, the machine readable instructions may be stored in multiple parts, which are individually compressed, encrypted, and/or stored on separate compute devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular compute device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media. In some examples, instructions stored on at least one non-transitory computer readable medium and/or at least one non-transitory computer readable storage medium may be executed to cause processor circuitry to perform one or more operations that the instructions implement.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine-readable instructions and/or example operations 800 that may be executed and/or instantiated by example processor circuitry to implement the example NIC 604 of FIG. 6. The NIC 604 may execute and/or instantiate the machine-readable instructions and/or operations 800 per traffic class according to a schedule set by the scheduling circuitry 646. The machine readable instructions and/or the operations 800 of FIG. 8 begin at block 802, at which the memory access control circuitry 614 fetches a descriptor of data from the shared memory 602 based on a descriptor head pointer (e.g., stored in the descriptor head pointer register 618). For example, the memory access control circuitry 614 initiates an upstream read transaction to obtain the descriptor. The data with which the example descriptor is associated is to be transmitted to a second device.

In the illustrated example of FIG. 8, at block 804, the memory access control circuitry 614 loads the descriptor into the descriptor cache 620. The descriptor cache 620 is local to the NIC 604. At block 806, the memory access control circuitry 614 parses the descriptor to determine a buffer pointer, a writeback address pointer, and a status pointer. For example, at block 806, the parsing circuitry 654 parses the descriptor to determine a buffer pointer, a writeback address pointer, and a status pointer. For example, the parsing circuitry 654 references a format of the descriptor to identify which rows of the descriptor include the buffer pointer, the writeback address pointer, and the status pointer. Based on the identification of respective rows of the descriptor, the parsing circuitry 654 extracts the bits representative of the buffer pointer, the writeback address pointer, and the status pointer. At block 808, the memory access control circuitry 614 generates a read request to the shared memory for payload data. For example, at block 808, the memory access control circuitry 614 generates the read request based on the buffer pointer.

In the illustrated example of FIG. 8, at block 810, the memory access control circuitry 614 causes storage of the writeback address pointer and the status pointer in the writeback address cache 622 according to an indexing mechanism. For example, at block 810, the parsing circuitry 654 generates an index for the writeback address pointer and the status pointer (e.g., converts the writeback address pointer and the status pointer to an indexed writeback address pointer and an indexed status pointer). In the example of FIG. 8, the writeback address cache 622 is local to the NIC 604. At block 812, the memory access control circuitry 614 loads the payload data into the MAC circuitry 612 in response to receipt of the payload data. For example, the memory access control circuitry 614 pushes the payload data to the transmission FIFO cache 648.

In the illustrated example of FIG. 8, at block 814, the memory access control circuitry 614 sets the control bit (e.g., the control bit 722) of the descriptor to indicate that the descriptor may be overwritten by an application executing on the main processor circuitry 606. For example, the memory access control circuitry 614 sets the control bit of the descriptor to a one to indicate that the descriptor may be overwritten by an application executing on the main processor circuitry 606. At block 816, the memory access control circuitry 614 flushes (e.g., deletes) the descriptor from the descriptor cache 620. At block 818, the MAC circuitry 612 indicates a timestamp and a status of transmission to the memory access control circuitry 614 in response to the transmission of the payload data to the second device as a packet.

In the illustrated example of FIG. 8, at block 820, the memory access control circuitry 614 causes storage of the timestamp and the status in the shared memory 602 based on the writeback address pointer and the status pointer. At block 822, the memory access control circuitry 614 generates an interrupt to the main processor circuitry 606. In examples disclosed herein the interrupt indicates that the packet has been transmitted. The memory access control circuitry 614 may generate the interrupt soon after transmission of the packet or the memory access control circuitry 614 may throttle interrupts as described above.

In the illustrated example of FIG. 8, at block 824, the memory access control circuitry 614 determines whether there is an additional descriptor in the shared memory 602. In response to the memory access control circuitry 614 determining that there is an additional descriptor in the shared memory 602 (block 824: YES), the machine-readable instructions and/or operations 800 return to block 802. In response to the memory access control circuitry 614 determining that there is not an additional descriptor in the shared memory 602 (block 824: NO), the machine-readable instructions and/or operations 800 terminate.

FIG. 9 is a block diagram of an example processor platform 900 structured to execute and/or instantiate the machine readable instructions and/or the operations of FIG. 8 to implement the NIC 604 of FIG. 6. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of compute device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes the example network interface circuitry (NIC) 604. The NIC 604 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the NIC 604 may also be referred to as a host fabric interface (HFI). In the example of FIG. 9, the NIC 604 is implemented on a separate die from the processor circuitry 912 (e.g., as part of an SoC).

In some examples, the NIC 604 is implemented on the same die as the processor circuitry 912. In additional or alternative examples, the NIC 604 is implemented within the same package as the processor circuitry 912. In some examples, the NIC 604 is implemented in a different package from the package in which the processor circuitry 912 is implemented. For example, the NIC 604 may be implemented as one or more add-in-boards, daughter cards, network interface cards, controller chips, chipsets, or other devices that may be used by the processor circuitry 912 to connect with another processor platform and/or other device.

In the illustrated example, one or more input devices 922 are connected to the NIC 604. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the NIC 604 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The NIC 604 of the illustrated example, thus, typically includes a graphics driver card, a graphics driver chip, and/or graphics processor circuitry such as a GPU.

In the illustrated example of FIG. 9, the NIC 604 implements the example on-chip system fabric (OSF) circuitry 608, the example data cache 610, the example media access control (MAC) circuitry 612, the example memory access control circuitry 614, the example descriptor tail pointer register 616, the example descriptor head pointer register 618, the example descriptor cache 620, the example writeback address cache 622, the example multiplexer 624, the example interface circuitry 626, the example gate control list (GCL) configuration interface 642, the example gate control list (GCL) cache 644, the example scheduling circuitry 646, the example transmission first in, first out (FIFO) cache 648, the example packetization circuitry 650, the example timer circuitry 652, and the example parsing circuitry 654. In some examples, the NIC 604 includes (e.g., is situated on the same PCB as) a communication device such as a transmitter, a receiver, a transceiver, a modem, a residential gateway, a wireless access point, and/or a network interface to facilitate exchange of data with external machines (e.g., compute devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 932 of FIG. 9 which may be implemented by the machine readable instructions and/or operations 800 of FIG. 8. The machine executable instructions 932 may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a general purpose microprocessor 1000. The general purpose microprocessor 1000 executes some or all of the machine readable instructions of the flowchart of FIG. 8 to effectively instantiate the circuitry of FIG. 6 as logic circuits to perform the operations corresponding to those machine readable instructions. In some such examples, the circuitry of FIG. 6 is instantiated by the hardware circuits of the microprocessor 1000 in combination with the instructions. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowchart of FIG. 8.

The cores 1002 may communicate by a first example bus 1004. In some examples, the first bus 1004 may implement a communication bus to effectuate communication associated with one(s) of the cores 1002. For example, the first bus 1004 may implement at least one of an Inter-Integrated Circuit (I2C) bus, a Serial Peripheral Interface (SPI) bus, a PCI bus, or a PCIe bus. Additionally or alternatively, the first bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry 1016 (sometimes referred to as an ALU and/or arithmetic and logic circuitry), a plurality of registers 1018, the L1 cache 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control data movement (e.g., coordinate data movement) within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may implement at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowchart of FIG. 8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowchart of FIG. 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowchart of FIG. 8. As such, the FPGA circuitry 1100 may be structured to effectively instantiate some or all of the machine readable instructions of the flowchart of FIG. 8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIG. 8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware_06 may implement the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine readable instructions of FIG. 8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowchart of FIG. 8 may be executed by one or more of the cores 1002 of FIG. 10, a second portion of the machine readable instructions represented by the flowchart of FIG. 8 may be executed by the FPGA circuitry 1100 of FIG. 11, and/or a third portion of the machine readable instructions represented by the flowchart of FIG. 8 may be executed by an ASIC. It should be understood that some or all of the circuitry of FIG. 6 may, thus, be instantiated at the same or different times. Some or all of the circuitry may be instantiated, for example, in one or more threads executing concurrently and/or in series. Moreover, in some examples, some or all of the circuitry of FIG. 6 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

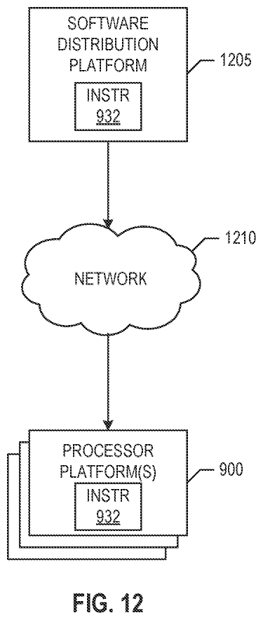

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other compute devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine-readable instructions and/or example operations 800 of FIG. 8, as described above. The one or more servers of the example software distribution platform 1205 are in communication with a network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions 932 of FIG. 9, may be downloaded to the example processor platform 900, which is to execute the machine readable instructions 932 to implement the NIC 604 of FIG. 6. In some example, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that improve bandwidth for packet timestamping. Example systems, methods, apparatus, and articles of manufacture disclosed herein increase the effective utilization of bandwidth in NICs. Additionally, examples disclosed herein are very area efficient as disclosed NICs store writeback address pointers (e.g., 8 bytes) instead of entire descriptors (e.g., 32 bytes). Also, examples disclosed herein reduce the amount of total descriptor cache as compared to existing NICs by half. Unlike some existing TSN NICs, examples disclosed herein do not need to increase storage for non-posted and completion credits that is otherwise required due to backpressure suffered by the configuration of those existing TSN NICs. Disclosed systems, methods, apparatus, and articles of manufacture improve the efficiency of using a compute device by solving packet timestamping and status update in a more bandwidth and silicon area efficient manner than the existing techniques. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to improve bandwidth for packet timestamping are disclosed herein. Further examples and combinations thereof include the following:

Example 1 includes an apparatus to improve bandwidth for packet timestamping comprising cache to store a pointer, the pointer indicative of an address in shared storage circuitry where a timestamp is to be stored, the pointer corresponding to a descriptor of data to be transmitted to a second device, and processor circuitry including one or more of at least one of a central processor unit (CPU), a graphics processor unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a first result of the one or more first operations, the instructions in the apparatus, a Field Programmable Gate Array (FPGA), the FPGA including first logic gate circuitry, a plurality of configurable interconnections, and storage circuitry, the first logic gate circuitry and the interconnections to perform one or more second operations, the storage circuitry to store a second result of the one or more second operations, or Application Specific Integrated Circuitry (ASIC) including second logic gate circuitry to perform one or more third operations, the processor circuitry to perform at least one of the first operations, the second operations, or the third operations to instantiate memory access control circuitry to parse the descriptor to determine the pointer, cause storage of the pointer in the cache, and set a control bit of the descriptor to indicate that the descriptor may be overwritten.

Example 2 includes the apparatus of example 1, wherein the address is a first address different from a second address in the shared storage circuitry where the descriptor is stored.

Example 3 includes the apparatus of any of examples 1 or 2, wherein the processor circuitry is to perform at least one of the first operations, the second operations, or the third operations to instantiate the memory access control circuitry to, in response to transmission of the data to the second device, cause storage of the timestamp at the address in the shared storage circuitry indicated by the pointer.

Example 4 includes the apparatus of any of examples 1, 2, or 3, wherein the address is a first address, the pointer is a first pointer, the cache is to store a second pointer indicative of a second address in the shared storage circuitry where a status of transmission of the data is to be stored, and the processor circuitry is to perform at least one of the first operations, the second operations, or the third operations to instantiate the memory access control circuitry to, in response to the transmission of the data to the second device, cause storage of the timestamp at the first address in the shared storage circuitry and the status at the second address in the shared storage circuitry.

Example 5 includes the apparatus of any of examples 1, 2, 3, or 4, wherein the cache is a first cache, and the processor circuitry is to perform at least one of the first operations, the second operations, or the third operations to instantiate the memory access control circuitry to cause storage of the pointer in the first cache according to an index, the index based on at least a queue of a second cache of the apparatus and a position of the data in the queue, the queue corresponding to a traffic class of the data.

Example 6 includes the apparatus of any of examples 1, 2, 3, 4, or 5, wherein the cache is a first cache, the descriptor includes an offset indicative of a first time at which the data is to be transmitted, and the processor circuitry is to perform at least one of the first operations, the second operations, or the third operations to instantiate the memory access control circuitry to cause storage of the data in a second cache of the apparatus at a second time, the second time different from the first time.

Example 7 includes the apparatus of any of examples 1, 2, 3, 4, 5, or 6, wherein the cache is a first cache, and the processor circuitry is to perform at least one of the first operations, the second operations, or the third operations to instantiate the memory access control circuitry to set the control bit of the descriptor in response to loading the data into media access control circuitry.

Example 8 includes network interface circuitry (NIC) to improve bandwidth for packet timestamping, the NIC comprising cache to store a pointer, the pointer indicative of an address in shared memory where a timestamp is to be stored, the pointer corresponding to a descriptor of data to be transmitted to a second device, and memory access control circuitry to parse the descriptor to determine the pointer, cause storage of the pointer in the cache, and set a control bit of the descriptor to indicate that the descriptor may be overwritten.

Example 9 includes the NIC of example 8, wherein the address is a first address different from a second address in the shared memory where the descriptor is stored.

Example 10 includes the NIC of any of examples 8 or 9, wherein the memory access control circuitry is to, in response to transmission of the data to the second device, cause storage of the timestamp at the address in the shared memory indicated by the pointer.

Example 11 includes the NIC of any of examples 8, 9, or 10, wherein the address is a first address, the pointer is a first pointer, the cache is to store a second pointer indicative of a second address in the shared memory where a status of transmission of the data is to be stored, and the memory access control circuitry is to, in response to the transmission of the data to the second device, cause storage of the timestamp at the first address in the shared memory and the status at the second address in the shared memory.

Example 12 includes the NIC of any of examples 8, 9, 10, or 11, wherein the cache is a first cache, and the memory access control circuitry is to cause storage of the pointer in the first cache according to an index, the index based on at least a queue of a second cache of the NIC and a position of the data in the queue, the queue corresponding to a traffic class of the data.

Example 13 includes the NIC of any of examples 8, 9, 10, 11, or 12, wherein the cache is a first cache, the descriptor includes an offset indicative of a first time at which the data is to be transmitted, and the memory access control circuitry is to cause storage of the data in a second cache of the NIC at a second time, the second time different from the first time.

Example 14 includes the NIC of any of examples 8, 9, 10, 11, 12, or 13, wherein the cache is a first cache, and the memory access control circuitry is to set the control bit of the descriptor in response to loading the data into media access control circuitry.

Example 15 includes at least one non-transitory computer readable medium comprising instructions that, when executed, cause processor circuitry to parse a descriptor to determine a pointer, descriptor associated with data to be transmitted from a first device to a second device, the pointer indicative of an address in shared memory where a timestamp is to be stored, cause storage of the pointer in a cache, the cache local to the processor circuitry, and set a control bit of the descriptor to indicate that the descriptor may be overwritten.

Example 16 includes the at least one non-transitory computer readable medium of example 15, wherein the address is a first address different from a second address in the shared memory where the descriptor is stored.

Example 17 includes the at least one non-transitory computer readable medium of any of examples 15 or 16, wherein the processor circuitry is to, in response to transmission of the data to the second device, cause storage of the timestamp at the address in the shared memory indicated by the pointer.

Example 18 includes the at least one non-transitory computer readable medium of any of examples 15, 16, or 17, wherein the address is a first address, the pointer is a first pointer, and the processor circuitry is to, in response to transmission of the data to the second device, cause storage of the timestamp at the first address in the shared memory and a status at a second address in the shared memory, the second address indicated by a second pointer.

Example 19 includes the at least one non-transitory computer readable medium of any of examples 15, 16, 17, or 18, wherein the cache is a first cache, and the processor circuitry is to cause storage of the pointer in the first cache according to an index, the index based on at least a queue of a second cache of the processor circuitry and a position of the data in the queue, the queue corresponding to a traffic class of the data.

Example 20 includes the at least one non-transitory computer readable medium of any of examples 15, 16, 17, 18, or 19, wherein the cache is a first cache, the descriptor includes an offset indicative of a first time at which the data is to be transmitted, and the processor circuitry is to cause storage of the data in a second cache of the processor circuitry at a second time, the second time different from the first time.

Example 21 includes the at least one non-transitory computer readable medium of any of examples 15, 16, 17, 18, 19, or 20, wherein the cache is a first cache, and the processor circuitry is to set the control bit of the descriptor in response to loading the data into media access control circuitry.

Example 22 includes an apparatus to improve bandwidth for packet timestamping, the apparatus comprising means for storing a pointer, the pointer indicative of an address in shared memory where a timestamp is to be stored, the pointer corresponding to a descriptor of data to be transmitted to a second device, and means for controlling memory access to parse the descriptor to determine the pointer, cause storage of the pointer in the means for storing, and set a control bit of the descriptor to indicate that the descriptor may be overwritten.

Example 23 includes the apparatus of example 22, wherein the address is a first address different from a second address in the shared memory where the descriptor is stored.

Example 24 includes the apparatus of any of examples 22 or 23, wherein the means for controlling memory access is to, in response to transmission of the data to the second device, cause storage of the timestamp at the address in the shared memory indicated by the pointer.

Example 25 includes the apparatus of any of examples 22, 23, or 24, wherein the address is a first address, the pointer is a first pointer, the means for storing is to store a second pointer indicative of a second address in the shared memory where a status of transmission of the data is to be stored, and the means for controlling memory access is to, in response to the transmission of the data to the second device, cause storage of the timestamp at the first address in the shared memory and the status at the second address in the shared memory.

Example 26 includes the apparatus of any of examples 22, 23, 24, or 25, wherein the means for storing is first means for storing, and the means for controlling memory access is to cause storage of the pointer in the first means for storing according to an index, the index based on at least a queue of second means for storing of the apparatus and a position of the data in the queue, the queue corresponding to a traffic class of the data.

Example 27 includes the apparatus of any of examples 22, 23, 24, 25, or 26, wherein the means for storing is first means for storing, the descriptor includes an offset indicative of a first time at which the data is to be transmitted, and the means for controlling memory access is to cause storage of the data in second means for storing of the apparatus at a second time, the second time different from the first time.

Example 28 includes the apparatus of any of examples 22, 23, 24, 25, 26, or 27, wherein the means for storing is first means for storing, and the means for controlling memory access is to set the control bit of the descriptor in response to loading the data into media access control circuitry.

Example 29 includes a method for improving bandwidth for packet timestamping, the method comprising parsing a descriptor to determine a pointer, descriptor associated with data to be transmitted from a first device to a second device, the pointer indicative of an address in shared memory where a timestamp is to be stored, storing, by executing an instruction with processor circuitry, the pointer in a cache, the cache local to the processor circuitry, and setting, by executing an instruction with the processor circuitry, a control bit of the descriptor to indicate that the descriptor may be overwritten.

Example 30 includes the method of example 29, wherein the address is a first address different from a second address in the shared memory where the descriptor is stored.

Example 31 includes the method of any of examples 29 or 30, further including storing, in response to transmission of the data to the second device, the timestamp at the address in the shared memory indicated by the pointer.

Example 32 includes the method of any of examples 29, 30, or 31, wherein the address is a first address, the pointer is a first pointer, and the method further includes storing, in response to transmission of the data to the second device, the timestamp at the first address in the shared memory and a status at a second address in the shared memory, the second address indicated by a second pointer.

Example 33 includes the method of any of examples 29, 30, 31, or 32, wherein the cache is a first cache, and the method further includes storing the pointer in the first cache according to an index, the index based on at least a queue of a second cache of the processor circuitry and a position of the data in the queue, the queue corresponding to a traffic class of the data.

Example 34 includes the method of any of examples 29, 30, 31, 32, or 33, wherein the cache is a first cache, the descriptor includes an offset indicative of a first time at which the data is to be transmitted, and the method further includes storing the data in a second cache of the processor circuitry at a second time, the second time different from the first time.

Example 35 includes the method of any of examples 29, 30, 31, 32, 33, or 34, wherein the cache is a first cache, and the method further includes setting the control bit of the descriptor in response to loading the data into media access control circuitry.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to improve bandwidth for packet timestamping comprising:
cache to store a pointer, the pointer indicative of an address in shared storage circuitry where a timestamp is to be stored, the pointer corresponding to a descriptor of data to be transmitted to a second device; and
processor circuitry including one or more of:
at least one of a central processor unit (CPU), a graphics processor unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a first result of the one or more first operations, the instructions in the apparatus;
a Field Programmable Gate Array (FPGA), the FPGA including first logic gate circuitry, a plurality of configurable interconnections, and storage circuitry, the first logic gate circuitry and the interconnections to perform one or more second operations, the storage circuitry to store a second result of the one or more second operations; or
Application Specific Integrated Circuitry (ASIC) including second logic gate circuitry to perform one or more third operations;
the processor circuitry to perform at least one of the first operations, the second operations, or the third operations to instantiate:
memory access control circuitry to:
parse the descriptor to determine the pointer;
cause storage of the pointer in the cache; and
set a control bit of the descriptor to indicate that the descriptor may be overwritten.

2. The apparatus of claim 1, wherein the address is a first address different from a second address in the shared storage circuitry where the descriptor is stored.

3. The apparatus of claim 1, wherein the processor circuitry is to perform at least one of the first operations, the second operations, or the third operations to instantiate the memory access control circuitry to, in response to transmission of the data to the second device, cause storage of the timestamp at the address in the shared storage circuitry indicated by the pointer.

4. The apparatus of claim 1, wherein the address is a first address, the pointer is a first pointer, the cache is to store a second pointer indicative of a second address in the shared storage circuitry where a status of transmission of the data is to be stored, and the processor circuitry is to perform at least one of the first operations, the second operations, or the third operations to instantiate the memory access control circuitry to, in response to the transmission of the data to the second device, cause storage of the timestamp at the first address in the shared storage circuitry and the status at the second address in the shared storage circuitry.

5. The apparatus of claim 1, wherein the cache is a first cache, and the processor circuitry is to perform at least one of the first operations, the second operations, or the third operations to instantiate the memory access control circuitry to cause storage of the pointer in the first cache according to an index, the index based on at least a queue of a second cache of the apparatus and a position of the data in the queue, the queue corresponding to a traffic class of the data.

6. The apparatus of claim 1, wherein the cache is a first cache, the descriptor includes an offset indicative of a first time at which the data is to be transmitted, and the processor circuitry is to perform at least one of the first operations, the second operations, or the third operations to instantiate the memory access control circuitry to cause storage of the data in a second cache of the apparatus at a second time, the second time different from the first time.

7. The apparatus of claim 1, wherein the cache is a first cache, and the processor circuitry is to perform at least one of the first operations, the second operations, or the third operations to instantiate the memory access control circuitry to set the control bit of the descriptor in response to loading the data into media access control circuitry.

8. Network interface circuitry (NIC) to improve bandwidth for packet timestamping, the NIC comprising:
cache to store a pointer, the pointer indicative of an address in shared memory where a timestamp is to be stored, the pointer corresponding to a descriptor of data to be transmitted to a second device; and
memory access control circuitry to:
parse the descriptor to determine the pointer;
cause storage of the pointer in the cache; and
set a control bit of the descriptor to indicate that the descriptor may be overwritten.

9. The NIC of claim 8, wherein the address is a first address different from a second address in the shared memory where the descriptor is stored.

10. The NIC of claim 8, wherein the memory access control circuitry is to, in response to transmission of the data to the second device, cause storage of the timestamp at the address in the shared memory indicated by the pointer.

11. The NIC of claim 8, wherein the address is a first address, the pointer is a first pointer, the cache is to store a second pointer indicative of a second address in the shared memory where a status of transmission of the data is to be stored, and the memory access control circuitry is to, in response to the transmission of the data to the second device, cause storage of the timestamp at the first address in the shared memory and the status at the second address in the shared memory.

12. The NIC of claim 8, wherein the cache is a first cache, and the memory access control circuitry is to cause storage of the pointer in the first cache according to an index, the index based on at least a queue of a second cache of the NIC and a position of the data in the queue, the queue corresponding to a traffic class of the data.

13. The NIC of claim 8, wherein the cache is a first cache, the descriptor includes an offset indicative of a first time at which the data is to be transmitted, and the memory access control circuitry is to cause storage of the data in a second cache of the NIC at a second time, the second time different from the first time.

14. The NIC of claim 8, wherein the cache is a first cache, and the memory access control circuitry is to set the control bit of the descriptor in response to loading the data into media access control circuitry.

15. At least one non-transitory computer readable medium comprising instructions that, when executed, cause processor circuitry to:
parse a descriptor to determine a pointer, descriptor associated with data to be transmitted from a first device to a second device, the pointer indicative of an address in shared memory where a timestamp is to be stored;
cause storage of the pointer in a cache, the cache local to the processor circuitry; and
set a control bit of the descriptor to indicate that the descriptor may be overwritten.

16. The at least one non-transitory computer readable medium of claim 15, wherein the address is a first address different from a second address in the shared memory where the descriptor is stored.

17. The at least one non-transitory computer readable medium of claim 15, wherein the processor circuitry is to, in response to transmission of the data to the second device, cause storage of the timestamp at the address in the shared memory indicated by the pointer.

18. The at least one non-transitory computer readable medium of claim 15, wherein the address is a first address, the pointer is a first pointer, and the processor circuitry is to, in response to transmission of the data to the second device, cause storage of the timestamp at the first address in the shared memory and a status at a second address in the shared memory, the second address indicated by a second pointer.

19. The at least one non-transitory computer readable medium of claim 15, wherein the cache is a first cache, and the processor circuitry is to cause storage of the pointer in the first cache according to an index, the index based on at least a queue of a second cache of the processor circuitry and a position of the data in the queue, the queue corresponding to a traffic class of the data.

20. The at least one non-transitory computer readable medium of claim 15, wherein the cache is a first cache, the descriptor includes an offset indicative of a first time at which the data is to be transmitted, and the processor circuitry is to cause storage of the data in a second cache of the processor circuitry at a second time, the second time different from the first time.

21. The at least one non-transitory computer readable medium of claim 15, wherein the cache is a first cache, and the processor circuitry is to set the control bit of the descriptor in response to loading the data into media access control circuitry.

22. An apparatus to improve bandwidth for packet timestamping, the apparatus comprising:
means for storing a pointer, the pointer indicative of an address in shared memory where a timestamp is to be stored, the pointer corresponding to a descriptor of data to be transmitted to a second device; and
means for controlling memory access to:
parse the descriptor to determine the pointer;
cause storage of the pointer in the means for storing; and
set a control bit of the descriptor to indicate that the descriptor may be overwritten.

23. The apparatus of claim 22, wherein the address is a first address different from a second address in the shared memory where the descriptor is stored.

24. The apparatus of claim 22, wherein the means for controlling memory access is to, in response to transmission of the data to the second device, cause storage of the timestamp at the address in the shared memory indicated by the pointer.

25. The apparatus of claim 22, wherein the address is a first address, the pointer is a first pointer, the means for storing is to store a second pointer indicative of a second address in the shared memory where a status of transmission of the data is to be stored, and the means for controlling memory access is to, in response to the transmission of the data to the second device, cause storage of the timestamp at the first address in the shared memory and the status at the second address in the shared memory.

26.-35. (canceled)
